(19) United States
(12) Patent Application Publication
(10) Pub. No.: US 2004/0153504 A1
(43) Pub. Date: Aug. 5, 2004

(54) Method and system for enhancing collaboration using computers and networking

(76) Inventors: Norman Hutchinson, Richmond (CA); Terry Coatta, Richmond, CA (US); Murray Goldberg, Vancouver (CA); Roy Kaufmann, Vancouver (CA); James Wright, Vancouver (CA); Joseph Wong, Vancouver (CA); Bruno Godin, Vancouver (CA); Dan Ferstay, North Vancouver (CA); Eddy Ma, Vancouver (CA)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/715,381

(22) Filed: Nov. 19, 2003

Related U.S. Application Data
(60) Provisional application No. 60/427,965, filed on Nov. 21, 2002.
(60) Provisional application No. 60/435,348, filed on Dec. 23, 2002.
(60) Provisional application No. 60/488,606, filed on Jul. 21, 2003.

(51) Int. Cl. G06F 15/16

(52) U.S. Cl. 709/204

(57) ABSTRACT

Methods, systems, and articles of manufacture consistent with the present invention provide a system and method for sharing and recording information on a wired or wireless computer network during synchronous and asynchronous sessions. A software program uses computers to enhance the collaboration, teaching, learning, presentation, and sharing of information and to record multi-media events for later playback and interaction with these events. Collaboration is enhanced by using features that allow broadcasting presentations, sharing, editing and replying to documents, taking notes, viewing participant information, creating and responding to polling questions, asking and answering questions and providing feedback on the pace and difficulty of the session.

### RELATED APPLICATIONS

This application is related to, and claims priority to the following U.S. Provisional Patent Applications which are hereby incorporated by reference herein:

U.S. Provisional Patent Application Serial No. 60/427,965, filed on Nov. 21, 2002, entitled “System and Method for Enhancing Collaboration using Computers and Networking.”

U.S. Provisional Patent Application Serial No. 60/435,348, filed on Dec. 23, 2002, entitled “Method and System for Synchronizing Data in Ad Hoc Networking Environments.”

U.S. Provisional Patent Application Serial No. 60/488,606, filed on Jul. 21, 2003, entitled “System and Method for Enhancing Collaboration using Computers and Networking.”

This application is also related to the following U.S. Patent Applications which are hereby incorporated by reference herein:

U.S. patent application Ser. No. ______, filed on ______, entitled “Method and System for Synchronous and Asynchronous Note Timing in a System for Enhancing Collaboration Using Computers and Networking.”

U.S. patent application Ser. No. ______, filed on ______, entitled “Method and System for Sending Questions, Answers and Files Synchronously and Asynchronously in a System for Enhancing Collaboration Using Computers and Networking.”

U.S. patent application Ser. No. ______, filed on ______, entitled “Method and System for Synchronizing Data in Peer to Peer Networking Environments.”

### BACKGROUND

1. Field of the Invention

The present invention generally relates to data processing systems, and more particularly, to a method and system for sharing and recording information on a wired or wireless computer network during synchronous and asynchronous sessions.

2. Background

Conventional collaboration and educational systems for teaching, learning and sharing of information typically provide either one of “synchronous” or “asynchronous” collaboration of remote computers to events and data associated with a central computer. Synchronous collaboration is collaboration that is in real-time, live or time dependent. Asynchronous collaboration is not in real-time, not live or time independent. Educational software packages exist which allow students at remote computers to logically connect to an instructor's computer at a central location. The software operating on the remote computers can interact either one of synchronously or asynchronously with the central computer.

These conventional systems typically lack a synergy of controls allowing both synchronous and asynchronous transactions for many of their features. They typically do not provide both synchronous and asynchronous operation through the same feature or software tool. Conventional systems typically focus on either the synchronous (real-time or time dependent) events or the asynchronous (non real-time or time independent) events. Conventional asynchronous software systems exist to maximize collaboration for distance learning by providing tools for participants to share information outside of a classroom environment. These systems enable participants to interact even though they are using the system at different times. On the other hand, conventional synchronous systems maximize collaboration in meetings and classrooms by providing tools for participants to share information in a live simultaneous communication session. In this case, participants are all assumed to be using the system at the same time. Both types of conventional systems lack the ability to transition in a simple way between synchronous and asynchronous events using the same software, methods, tools and interfaces. These conventional systems have not maximized the collaboration both synchronously and asynchronously.

Additionally, conventional applications typically provide control over the playback of a recording using software buttons that allow for fast forward, rewind, go to the beginning, or go to the end. A problem with these systems is that they typically do not provide a quick way to locate and navigate to particular content contained in the recording. While conventional systems use navigational control mechanisms that may be suitable for some types of recordings such as typical video and audio recordings, they are not designed to provide an easy way to quickly access specific and varied events in a multi-stream recording.

Conventional systems also enable playback of recorded material without the possibility of interacting with the recording during the playback. Conventional systems play back information-rich recordings exactly as they were recorded without the ability to interact with the playback or focus on different information aspects of the recordings.

Furthermore, conventional systems typically use one of a variety of formats intended for dealing with multi-media data streams (e.g., AVI, ASF, MPEG, and QuickTime). However, these formats operate almost exclusively in the domain of audio, video, and image data streams. Further, these formats do not provide application-programming interfaces (“APIs”) that support the simultaneous recording and editing of data streams. Because these conventional system formats focus on the support of audio or video, they are only optimized for the delivery of event streams with fixed inter-event latency and low tolerance for jitter, and are not suited to event streams without fixed latency or varying sizes of events.

Therefore, a need has long existed for a method and system that overcome the problems noted above and other related problems.

### SUMMARY

Methods, systems, and articles of manufacture consistent with the present invention include a system and method embodied in a software and hardware system which enhances communication and collaboration by providing an information-rich environment for interacting with and capturing the knowledge presented in a live collaboration session in meeting and classroom settings. Participants using the system on their computers may broadcast and receive presentations (e.g., slides or any displayable application), record the audio track of the session, take notes, ask and answer questions about the material that the instructor presented, provide feedback about the pace and comprehension of the session, and ask and present polling questions and answers. They may also send and receive files, share and edit documents and see profiles on participants, control which applications are running on a participant's machine, chat, take quizzes and carry out collaborative research activities. In one implementation, the capture of information is done by recording aspects of the live session that are mediated or observed by the system. The recording of the session can be replayed by participants outside of the live session to review, study, and interact with the material.

A method in data processing system for collaboration is provided that comprises the steps of receiving a first request to perform an operation synchronously with a live session by a collaboration tool, and executing the operation in response to the first synchronous request by the collaboration tool. The method further comprises receiving a second request to perform the same operation asynchronously with a live session by the collaboration tool, and executing the operation in response to the second asynchronous request by the collaboration tool.

Furthermore, a method for in a data processing system for collaboration is provided that comprises the steps performed by a collaboration tool of displaying a graphical user interface including a plurality of operations, and receiving a request to perform one of the operations in a synchronous manner. The method further comprises receiving a request to perform the one operation in an asynchronous manner.

Additionally, a method in a data processing system for collaboration is provided that comprises the steps of recording a live interactive presentation with interactive elements, and playing the recording of the live presentation such that a user is able to interact with the interactive elements.

A data processing system for collaboration is provided that comprises a memory comprising a program that receives a first request to perform an operation synchronously with a live session by a collaboration tool, executes the operation in response to the first synchronous request by the collaboration tool, receives a second request to perform the same operation asynchronously with a live session by the collaboration tool, and executes the operation in response to the second asynchronous request by the collaboration tool. The data processing system further comprises a processor for running the program.

Furthermore, a data processing system for collaboration is provided that comprises a memory comprising a program that causes a collaboration tool to display a graphical user interface including a plurality of operations, receive a request to perform one of the operations in a synchronous manner, and receive a request to perform the one operation in an asynchronous manner. The data processing system further comprises a processor for running the program.

Additionally, a data processing system for collaboration is provided that comprises a memory comprising a program that records a live interactive presentation with interactive elements, and plays the recording of the live presentation such that a user is able to interact with the interactive elements. The data processing system further comprises a processor for running the program.

### BRIEF DESCRIPTION OF DRAWINGS

The foregoing and other aspects of the invention will become more apparent from the following description of specific embodiments thereof and the accompanying drawings which illustrate, by way of example, the principles in accordance with the present invention.

FIG. 1 depicts a block diagram of an exemplary collaboration session including students and an instructor operating computers in accordance with methods and systems consistent with the present invention.

FIG. 2 depicts an exemplary system diagram of a system upon which methods and systems consistent with the present invention may be practiced.

FIG. 3 depicts a block diagram of exemplary elements of an exemplary system consistent with the present invention.

FIG. 4 depicts a pictorial representation of an exemplary window generated by the system shown in FIG. 3 for broadcasting a presentation.

FIG. 5 depicts a pictorial representation of an exemplary window generated by the system shown in FIG. 3 for sharing files.

FIG. 6 depicts the steps in an exemplary method for sending data such as files, questions, answers, quizzes, etc., synchronously or asynchronously using presence awareness.

FIG. 7 depicts a pictorial representation of an exemplary window generated by the system shown in FIG. 3 for polling questions.

FIG. 8 depicts a pictorial representation of an exemplary window generated by the system shown in FIG. 3 for asking and answering questions.

FIG. 9 depicts a pictorial representation of an exemplary window generated by the system shown in FIG. 3 for creating notes.

FIG. 10 depicts a pictorial representation of an exemplary window generated by the system shown in FIG. 3 for providing feedback to the instructor and displaying a participant list.

FIG. 11 depicts a pictorial representation of an exemplary window generated by the system shown in FIG. 3 for displaying multi-stream recordings.

FIG. 12 depicts a pictorial representation of an exemplary window generated by the system shown in FIG. 3 for searching text across and within multi-stream recordings.

FIG. 13 depicts a pictorial representation of an exemplary window generated by the system shown in FIG. 3 for the playback of multi-stream recordings.

FIG. 14 depicts a block diagram of relationships of exemplary visual components to infrastructure components of the system of FIG. 3.

FIG. 15 shows exemplary steps in an exemplary method for message delivery by the Messenger.

FIG. 16 depicts a block diagram of modules and their interaction for a representative tool provided by the system of FIG. 3 in Live mode.

FIG. 17 depicts a block diagram of modules and their interaction for a representative tool provided by the system of FIG. 3 in Playback mode.

FIG. 18 depicts a block diagram of a Nexus, a component of the system that provides services for the recording and playing back of multiple media streams.

FIG. 19 depicts an exemplary architecture of a subsystem for generating search indices.

FIG. 20 depicts an exemplary format of a search buffer map.

FIG. 21 depicts an exemplary format of a recording on a storage medium.

### DETAILED DESCRIPTION

Overview

Methods, systems, and articles of manufacture consistent with the present invention include a system and method embodied in a software and hardware system which enhances communication and collaboration by providing an information-rich environment for interacting with and capturing the knowledge presented in a live collaboration session in meeting and classroom settings. Participants using the system on their computers may broadcast and receive presentations (e.g., slides or any displayable application), record the audio track of the session, take notes, ask and answer questions about the material that the instructor presented, provide feedback about the pace and comprehension of the session, and ask and present polling questions and answers. They may also send and receive files, share and edit documents and see profiles on participants, control which applications are running on a participant's machine, chat, take quizzes and carry out collaborative research activities. In one implementation, the capture of information is done by recording all aspects of the live session that are mediated or observed by the system. The recording of the session can be replayed by participants outside of the live session to review, study, and interact with the material.

An exemplary system consistent with the present invention provides both synchronous and asynchronous collaboration using the same methods, processes and tools. In one implementation, the system uses the same graphical user interface to access and share information whether participants are in a live session or not. This may create an experience for the user that appears the same whether they are in a live session or not. The exemplary system may use the same software tools or modules whether user interaction is synchronous or asynchronous.

The exemplary system also enables distance students to participate in live collaboration sessions. As an example, instructors can conduct a class that includes both students in a real-time lecture setting as well as students off campus using the same system software. The group of participants in a live session may use the system in wireless mode or wired local area network (“LAN”) configuration. In the case of a wireless configuration, the system has features to allow use of the wireless network in a peer-to-peer mode. The system also incorporates quality of service mechanisms that adjust to variances in bandwidth and latency of the network. Students located off campus can join a live session using the system by remotely connecting to a central server to communicate with the instructor and the rest of the participants. In one implementation, all the same features of the system are available to both groups of students. In contrast, conventional systems have not enabled the integration of off campus students using a wide area network (“WAN”) connection into a LAN using the same collaboration software.

The exemplary system provides an easy way to quickly retrieve events with random access that were recorded during a live session, whereas conventional systems include software applications that simply enable the playback of recorded information. In contrast to conventional navigational control mechanisms such as fast forward, rewind, beginning and end, the exemplary system provides a process for recording and efficiently accessing specific events derived from varied and non-uniform sources. An “event” is an arbitrary sized, self-contained unit of data produced at a particular point in time. A “stream” is a time-ordered sequence of events, often generated by a single component or set of related components.

The exemplary system also provides interaction with recordings while the recording is being reviewed. The exemplary system enables users to interact with the recording by using tools that were used during the recording of the initial live session. For example, interactive elements of the exemplary system may include, but are not limited to accessing, creating, and modifying polling questions, shared documents, questions, answers, quizzes, feedback and notes, all while reviewing a particular recording. For example, the exemplary system includes a note taking facility that is integrated with the overall recording capabilities of the application. These notes are seamlessly recorded as part of the whole session. When the recording is reviewed after it has been completed, users can edit these notes directly during playback. Changes made during playback are automatically integrated into the recording.

Similarly, the exemplary system also provides the ability to dynamically change the focus of information in a recording by altering the display during playback. The exemplary system enables users to select, display, manipulate, view and re-position information from different media streams while playing the recording of a session. This provides the ability to focus on different aspects of the multi-media information during playback.

The exemplary system provides real-time as well as the more traditional post-hoc editing of the recording. Editing can be done during a live session, while the system is recording, or after the recording has been completed. While conventional systems enable the post-hoc editing of multi-media streams, they do not enable the modification of an event stream as it is being recorded. The exemplary system enables the modification, deletion, or insertion of new data into the stream while the recording is being made or played back.

The exemplary system additionally provides the ability to search multi-stream recordings. Conventional systems provide searching of single streams of information allowing for partial searches if multiple streams of information are present. In contrast, the exemplary system enables information from each of the different streams of information to be searched using a uniform and single graphical user interface, thus providing a transparent method of searching diverse sources of information using a simple and single search input mechanism. The results are displayed in summary form or in the recording itself in a uniform way regardless of the stream of information. Additionally, each search result is associated with a time index that identifies at what point within the recording the search term occurred.

The exemplary system implements a recording format that supports the recording of arbitrary event streams with varying characteristics of event latency, event distribution, and event size. In contrast, conventional systems focus on the support of standard media types such as audio and video, which have very specific properties in terms of size, frequency, and tolerance for latency. The exemplary system enables the recording and playback of event streams with widely varying properties. The infrastructure for playing these event streams ensures that the event-processing overhead associated with one stream does not interfere with the delivery of events on other streams. This supports the simultaneous playback of latency/jitter sensitive event streams such as audio and video and other streams with higher data volume or data processing needs but which are not as sensitive to timing variations. The event streams are integrated into a unified recording on disk. The recording mechanism also protects against loss of data when the computer making the recording fails. Data is streamed in real-time out to the disk in such a way that if the computer fails, only a small portion of the recording prior to the failure is lost.

System

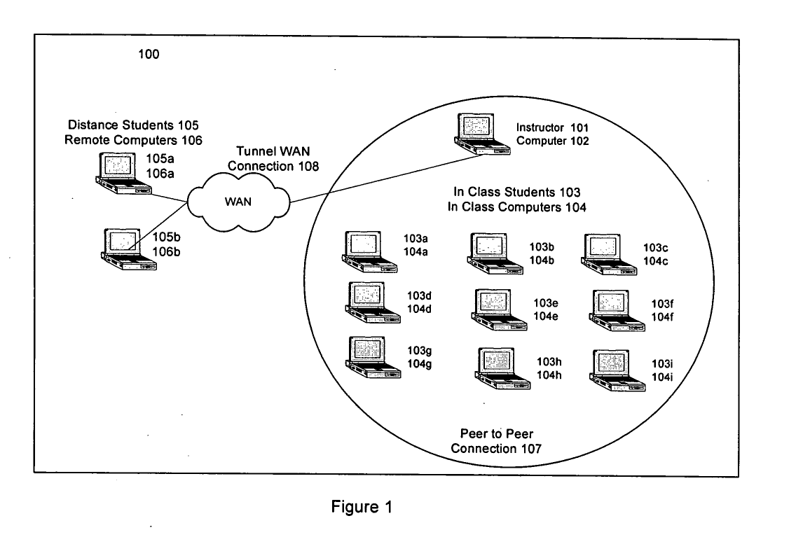

FIG. 1 depicts an exemplary collaboration session 100 generated and used by an exemplary system comprising students and an instructor operating computers with software in accordance with methods and systems consistent with the present invention. The instructor 101 is using a computer 102. One group of students 103 in the classroom is communicating with the instructor 101 using their computers 104. In one implementation, the instructor's computer 102 and in class students' computers 104 communicate using a peer-to-peer wireless connection 107. These computers 102 and 104 can be connected either wirelessly as shown, for example, either using an access point or in a peer to peer mode, or using a wired LAN connection (not shown). Another group of distance students 105 is not located in the classroom but also participates in the collaboration session using their computers 106. In one implementation, their computers 106 are communicating with the instructor's computer 102 using a network tunnel through a wired WAN connection 108. Students in the classroom 103 and distance students 105 can communicate using their computers (104 and 106 respectively) by communicating through the instructor's central computer 101. Individual recordings of the live session may be created and saved on each of the computers 102, 104, and 106.

The system addresses the issue of limited bandwidth over the wireless network through the use of broadcast/multicast communications. This ensures that the required bandwidth does not grow with the number of participants in the session. However, broadcast/multicast communications over wireless networks may be less reliable than unicast communications, and the software incorporates several techniques to improve the level of reliability. Due to the limited bandwidth of wireless networks, the software also implements quality of service provisions that make it possible, for example, to ensure expedited delivery of digital audio. In a similar fashion, a server component that supports access to the classroom environment by remote participants incorporates a number of mechanisms to prioritize, transcode, or discard data based on the bandwidth available for each client.

A recording is a collection of streams that have a common time basis. In addition, a recording may also contain associated meta-data that supports attributes such as when the recording was made, how long it is, etc.

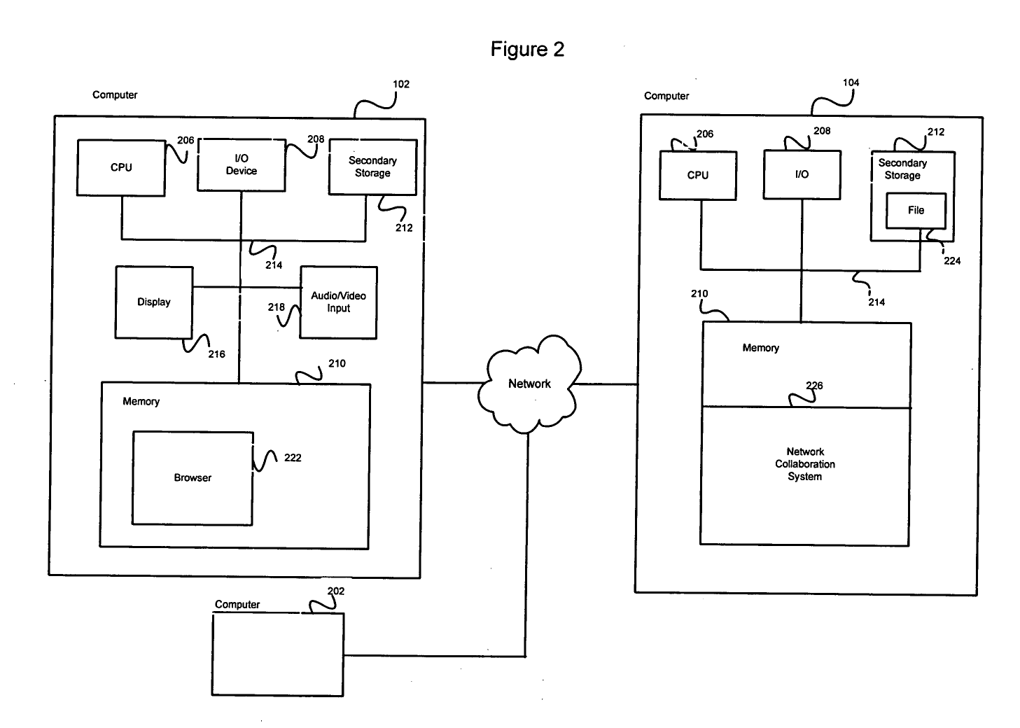

FIG. 2 depicts an exemplary data processing system suitable for use in accordance with methods and systems consistent with the present invention. FIG. 2 shows two exemplary computers 102 and a computer 104 connected to a network, which may be wired or wireless, and may be a LAN or WAN, and any of the computers may represent any kind of data processing computer, such as a general-purpose data processing computer, a personal computer, a plurality of interconnected data processing computers, video game console, clustered server, a mobile computing computer, a personal data organizer, a mobile communication computer including mobile telephones or similar computers. The computers 102 and 104 may represent computers in a distributed environment, such as on the Internet. The computers 104, may represent students' computers while computer 102 may represent an instructor's computer. There may also be many more computers 102 and 104 than shown on the figure.

A computer 102 includes a central processing unit (“CPU”) 206, an input-output (“I/O”) unit 208 such as a mouse or keyboard, or a graphical input computer such as a writing tablet, and a memory 210 such as a random access memory (“RAM”) or other dynamic storage computer for storing information and instructions to be executed by the CPU. The computer 102 also includes a secondary storage computer such as a magnetic disk or optical disk that may communicate with each other via a bus 214 or other communication mechanism. The computer 102 may also include a display 216 such as such as a cathode ray tube (“CRT”) or LCD monitor, and an audio/video input 218 such as a webcam and/or microphone.

Although aspects of methods and systems consistent with the present invention are described as being stored in memory 210, one having skill in the art will appreciate that all or part of methods and systems consistent with the present invention may be stored on or read from other computer-readable media, such as secondary storage computers, like hard disks, floppy disks, and CD-ROM; a carrier wave received from a network such as the Internet; or other forms of ROM or RAM either currently known or later developed. Further, although specific components of the data processing system are described, one skilled in the art will appreciate that a data processing system suitable for use with methods, systems, and articles of manufacture consistent with the present invention may contain additional or different components. The computer 102 may include a human user or may include a user agent. The term “user” may refer to a human user, software, hardware or any other entity using the system. A user of a computer may include a student of a class or an instructor.

As shown, the memory 210 in the computer 102 may include a browser 222 which is an application that is typically any program or group of application programs allowing convenient browsing through information or data available in distributed environments, such as the Internet or any other network including local area networks. A browser application 222 generally allows viewing, downloading of data and transmission of data between data processing computers. The browser 222 may also be other kinds of applications.

Although only one browser 222 is shown, any number of browsers may be used. Additionally, although shown on the computer 102 in the memory 210, these components may reside elsewhere, such as in the secondary storage 212, or on another computer, such as another computer 102. Furthermore, these components may be hardware or software whereas embodiments in accordance with the present invention are not limited to any specific combination of hardware and/or software. The memory 210 also includes a network collaboration system 226.

FIG. 2 also depicts a computer 104 that includes a CPU 206, an I/O unit 208, a memory 210, and a secondary storage computer 212 having a file 224 that communicate with each other via a bus 214. The memory may store a network collaboration system 226 which manages the functions of the computer and interacts with the file 224. The file 224 may store recorded data, data to be shared, information pertaining to statistics, user data, multi media files, etc. The file 224 may also reside elsewhere, such as in memory 210. The computer 104 may also have many of the components mentioned in conjunction with the computer 102. There may be many computers 104 working in conjunction with one another. The system 226 may be implemented in any way, in software or hardware or a combination thereof, and may be distributed among many computers. It may be represented by any number of components, processes, threads, etc.

The computer 102 and computer 104 may communicate directly or over networks, and may communicate via wired and/or wireless connections, including peer-to-peer wireless networks 107, or any other method of communication. Communication may be done through any communication protocol, including known and yet to be developed communication protocols. The network may comprise many more computers 102 and computers 104 than those shown on the figure, and the computers may also have additional or different components than those shown.

It will be appreciated that various modifications to detail may be made to the embodiments as described herein, all of which would come within the scope of the invention. It is noted that the above elements of the above examples may be at least partially realized as software and/or hardware. Further, it is noted that a computer-readable medium may be provided having a program embodied thereon, where the program is to make a computer or system of data processing computers execute functions or operations of the features and elements of the above described examples. A computer-readable medium may include a magnetic or optical or other tangible medium on which a program is embodied, but can also be a signal, (e.g., analog or digital), electromagnetic or optical, in which the program is embodied for transmission. Further, a computer program product may be provided comprising the computer-readable medium.

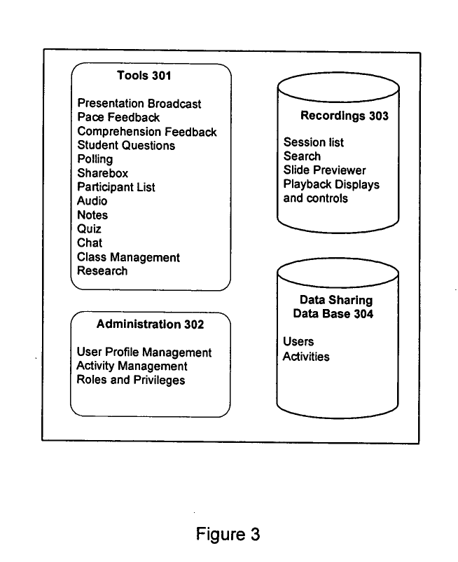

FIG. 3 depicts a functional overview of an exemplary system consistent with the present invention that is operating on instructor and student computers 102, 104 and 106. The system includes features that provide presentation, collaboration and learning facilities for a classroom or meeting environment including presentation broadcast, audio, anonymous student feedback, student polling and reporting, student questions, collaboration through shared document editing, note-taking, participant lists, quiz taking, chat, class management and research tools. The system provides full recordings of the classroom activities that include the information and interaction that took place during the live session. The system features can be used in synchronous (live and interactive) sessions and asynchronous (off-line) sessions.

In a synchronous session, the exemplary system is used in a live classroom environment to enhance the collaboration between instructors and participants during a teaching and learning session. In an asynchronous session, the exemplary system is used outside of live class time with the same tools to access and use information used during the teaching and learning session.

The blending of synchronous (simultaneous in-classroom) communication and asynchronous (non-simultaneous or non-live) communication outside the classroom provides advantages for both the instructor 101 and participants that has not been addressed by conventional systems. The mechanisms and advantages of this blending of synchronous and asynchronous are described in references to specific tools 301 that are shown with respect to the collaboration features.

A collaboration tool may be a program, application or module that facilitates the sharing of information between two or more persons. A collaboration tool may provide a person with a variety of interactive elements via which the person may exchange information and coordinate with one or more other persons. A particular collaboration tool may be associated with a protocol via which it exchanges and coordinates with other instances of that tool. Examples of collaboration tools may include the question and answer tool, sharing tool, polling tool, quiz tool, and class management tools. Collaboration tools may include various functionality including a variety of operations such as, for example, sending a question, sending an answer in response to a question, sending a file, sending a quiz, broadcasting a presentation, sending a response to a quiz, provide feedback, present polling questions, etc.

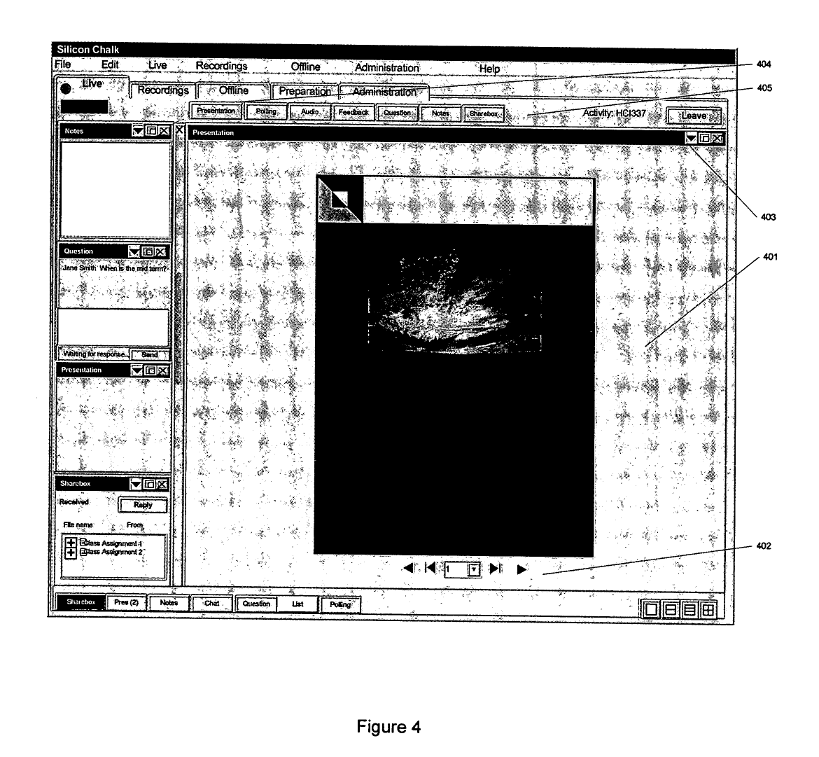

A functional unit within the software supports live collaboration features. These features, described as “tools 301” include, but are not limited to: pace and comprehension feedback where participants provide immediate feedback to the instructor, a list of participants, student questions and the ability for instructors to answer, polling questions and answers, file and document sharing, presentation broadcast, and note-taking. These tools 301 are described in conjunction with FIGS. 4, 5 and 7-10 which depict exemplary graphical user interfaces. Audio, quiz taking, chat and research tools are also described as part of the exemplary functional unit 301 displayed in FIG. (3).

The Administrative functional unit 302 supports administrative functions. These include, for example, the ability to create and manage accounts, create and manage activities such as courses and their details, add users and user profile information, assign roles to individuals where roles determine the privileges for using different features and set user preferences.

The exemplary system also provides quick and easy access to specific events in a multi-stream recording. Exemplary graphical elements that surpass the usual playback controls found in conventional systems are included in the exemplary system to: (1) provide a simplified overview of the recording to indicate the general content of the recording including the number and type of significant events, (2) provide a preview of slides or graphics contained within particular streams of the multi-stream recording, (3) minimize the steps to navigate to different events and points within the recording, (4) search for text in multi-stream recordings using a single user interface, and (5) filter events from different streams of information to display only those that are of interest.

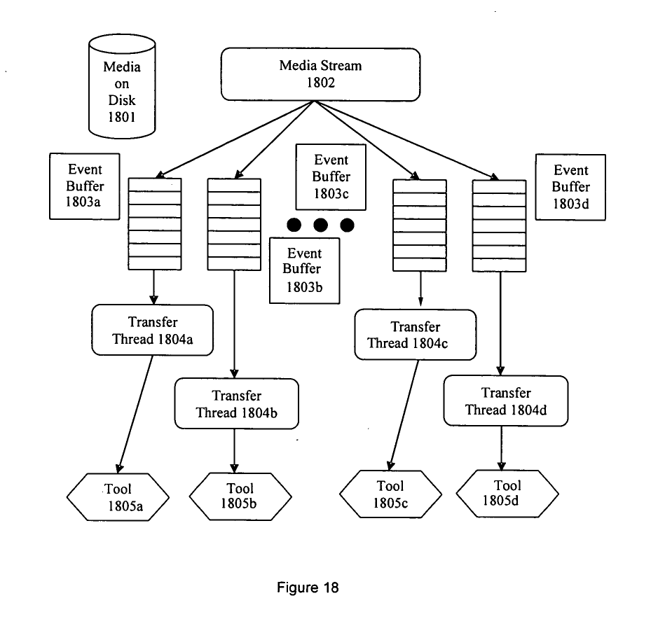

The Recordings functional unit 303 supports the capture, storage and display of recordings. An exemplary internal architecture of a Recordings functional unit 303 is described below with regard to FIG. 18. The following discussion regards external features supported by the Recordings functional unit 303.

Multi-stream recordings supported by an exemplary system consistent with the present invention use a recording format that supports arbitrary event streams with varying characteristics of latency, event distribution, and size. The exemplary system also supports on-the-fly editing of already recorded data. To support playback, event streams are regenerated in such a manner as to preserve the original timing of the events in each stream, and across streams as well.

In one implementation, the Recordings functional unit 303 supports event streams having the following exemplary properties: (1) fixed or variable latency between events, (2) fine-grained sequencing of events with a time resolution, for example, on the order of 10 milliseconds, (3) significant variance in the size of events, for example, from 1 byte to hundreds of thousands of bytes, and (4) significant variance in the processing associated with each event.

For example, an audio stream may include events that occur at regular intervals, with an inter-event latency of 20 to 100 milliseconds, and 500 to 4000 bytes per event. Events from the presentation broadcast tool, in contrast, typically do not occur with fixed latency, may vary in size from hundreds of bytes to hundreds of thousands of bytes, and may need substantial processing in order to be acted upon. A challenge presented by this variability is to be able to simultaneously satisfy the performance needs of multiple media streams and to support them via a single file format that enables events from different sources to be correlated in time with each other.

While the present exemplary system media format and software support simultaneous recording and editing of data streams as well as standard multimedia data streams (e.g., AVI, ASF, MPGG, and QuickTime), they also support event streams where the inter-event latency is not fixed, event sizes may vary significantly, and the overhead of application level event processing varies from event to event. An advance achieved by the system is that these event streams can be combined in a single unified recording without sacrificing the latency/jitter requirements of the contained audio/video streams. In one implementation, the exemplary system includes at least two features that extend beyond conventional systems and existing standards with respect to the recording and playback of multi-media data.

First, a session includes a user accessing and using a variety of different tools 301 (e.g., tools to take notes, to ask questions, and to respond to questions from the instructor). Along with the ability to record multiple streams, the behaviour of all of these tools is permitted and reproduced during playback of a session. Exemplary playback mechanisms described herein go beyond conventional systems that simply record and playback the images from multi-media.

The technique of simply recording images presents at least two possible disadvantages. First, the tools used during live sessions often manipulate data that has semantic content that would not be captured through a recording of the display of the tool. Many conventional recordings made by software are simply a record of what the tool looked like during the live session. For example, an exemplary note tool as described herein manipulates text. If that text were recorded only as an image, searching for a particular word or phrase in the recording may be difficult. In order to retain the full semantics of the data, the data may need to be recorded in a format that is particular to each tool. Second, the volume of data recorded for images would frequently be significantly larger than the corresponding data recorded in a tool-specific format. For example, an image of a page of notes takes up far more space than the sequence of characters representing those notes. In light of these two factors, the underlying storage format of an exemplary system consistent with the present invention supports the recording of arbitrary application content rather than simple images or video streams.

A second feature of the exemplary system enables editing of a data stream at the same time as it is being recorded or played back. This is beneficial at least because some of the features of the exemplary system (such as the note-taking tool) involve user editing of already recorded data. That is, when a user edits text that was entered earlier in the session, the note-taking tool may need to edit events that have already been recorded to disk. These editing operations may even alter the timestamps of previously recorded data, or insert and delete segments of time. An exemplary architecture used to support these features is described below with regard to FIG. 18.

FIG. 4 depicts an exemplary graphical user interface for the presentation broadcast tool 401 shown in FIG. 3. During a live session, a user can select an application to broadcast to participants 103, 105 of an activity by selecting a Presentation button 404 on a live tool button bar 405. In response, the selected broadcast is displayed in the main window of the presentation tool 401. Participants receive and record this broadcast as part of the session recording. In one exemplary implementation, a host user (instructor) 101 can broadcast up to two presentations simultaneously; however, in other implementations, more than two presentations may be broadcast simultaneously as well. The application to be broadcast can be selected, for example, by: (1) choosing from a list of open applications, (2) choosing one of the live the system tools, (3) selecting a file from a browser, (4) selecting from a list of most recently used applications (5) or by manually selecting the application using the mouse cursor. The broadcast may typically be a PowerPoint presentation but can be any application that can be displayed in a window (e.g., an internet browser). Instructors 101 can control the display of their PowerPoint presentation using the control features available in the presentation tool 402. They may go forward, backward, and jump to a particular slide by selecting navigation keys or entering specific slide numbers. This provides an easy way to display and navigate a presentation without having to switch to a PowerPoint application to control the slide show. Instructors 101 can change the default settings that are used to optimize the presentation broadcast by selecting one of the option items under the presentation broadcast options menu 403. These options may include: (1) the rate of sending the presentation to participants, (2) smart difference calculations in which the system compares the current frame with the last frame and attempts to send only the differences between the two, (3) layering which is a control setting that controls some aspects of what is broadcast such as when a window is minimized, (4) default settings for different types of applications and (5) default selection method which is a mechanism by which the user indicates what material they would like to broadcast. Available mechanisms may include simply choosing a file, running an application choosing the output of a specific tool, etc.

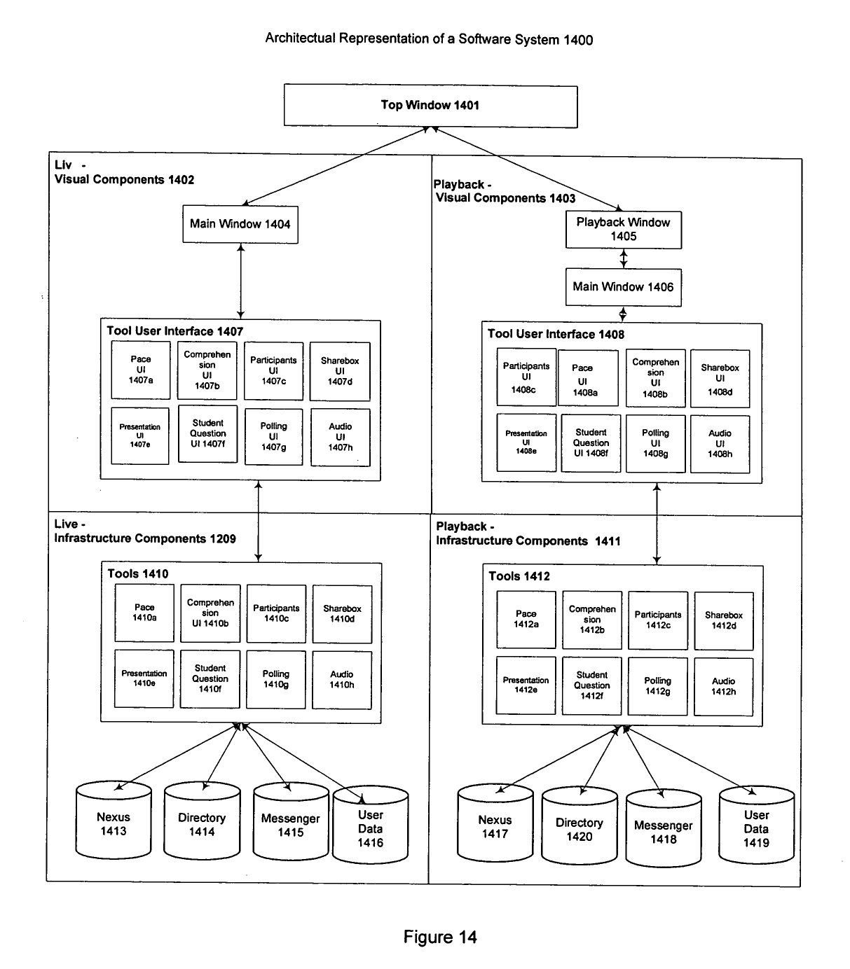

Users (instructors 101 and students 103, 105) may enter an index mark on a presentation broadcast by selecting an option item 403. This enables users to mark a spot in the presentation for later reference. During playback, users can view the user-entered indexes as pages in the slide overview. These indexes provide a reference mark when viewing the presentation. Exemplary implementation techniques used for the live presentation tool are described with regard to FIG. 14 (1407e, 1410e) and the playback of the presentation tool with regard to FIG. 14 (1408e, 1412e).

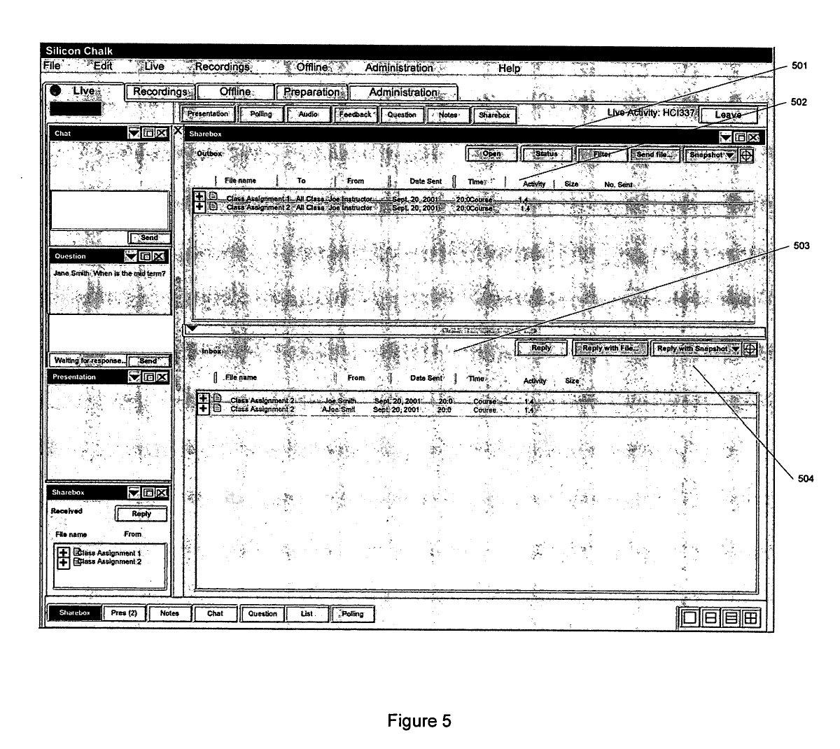

FIG. 5 depicts an exemplary graphical user interface provided to instructors 101 and students 103, 105 using a Sharebox feature of the software shown in FIG. 3. The Sharebox 501 can be started by selecting the Sharebox button from the live tool button bar 405. The Sharebox 501 enables access to documents and files during both synchronous and asynchronous sessions. These files may be stored on the local user database 204. The Sharebox 501 provides instructors 101 with a method of sending files to students 103, 105 during a live session. Students 103, 105 may edit the files and return them to the instructor 101.

Exemplary functions of the Sharebox 501 include the ability to view files, open existing files, view the status of sent files, filter files by replies to selected files, send files and send bitmaps of selected applications. By default, in one implementation, files are sent to all users 101, 103 and 105. Incoming files are displayed with summary information in the Inbox 502, and files that have been sent are displayed with summary information in the Outbox 503. Exemplary functions 504 used when responding to incoming files include: (1) a quick reply function which automatically sends the user's modified file back to the instructor 101, (2) a reply with another file which enables users to first select a file browser and then send the file to the instructor 101, and (3) a reply with an image from an open application which enables users to select a window on their desktop. The system creates a file containing an image of that window and sends the file to the instructor 101.

The Sharebox 501 may be used asynchronously outside of a live session using the same exemplary graphical user interface displayed with regard to FIG. 5. Users can access the same files exchanged during a live session off-line or outside of the live session by selecting the Sharebox 501 in the off-line mode. Users may view and edit files that they received during a live session. A difference in using the Sharebox 501 in asynchronous sessions may be that files are placed in a pending state that will be sent automatically by the system when appropriate. This ability to adapt transparently to the current level of network connectivity represents an advance over conventional systems. When a user sends a file with the Sharebox 501, the software determines the user's current context. If the user is in a live session, and the intended recipient is also present in that session, then the file will be delivered immediately. However, for situations in which immediate delivery is not possible, the software places the file in a queue for later delivery. This queuing mechanism monitors when users join and leave sessions, and is thus able to selectively deliver the file when its intended recipient is known to be available. By incorporating presence awareness, the file delivery mechanism is thus able to support synchronous and asynchronous uses of the Sharebox 501 with similar constructs. The queuing and delivery mechanism (Messenger) used by the Sharebox 501 is discussed below for the live mode 1415 and for the playback mode 1418. The implementation techniques used for the Sharebox in live 1407 and playback 1408 are discussed with regard to FIG. 14.

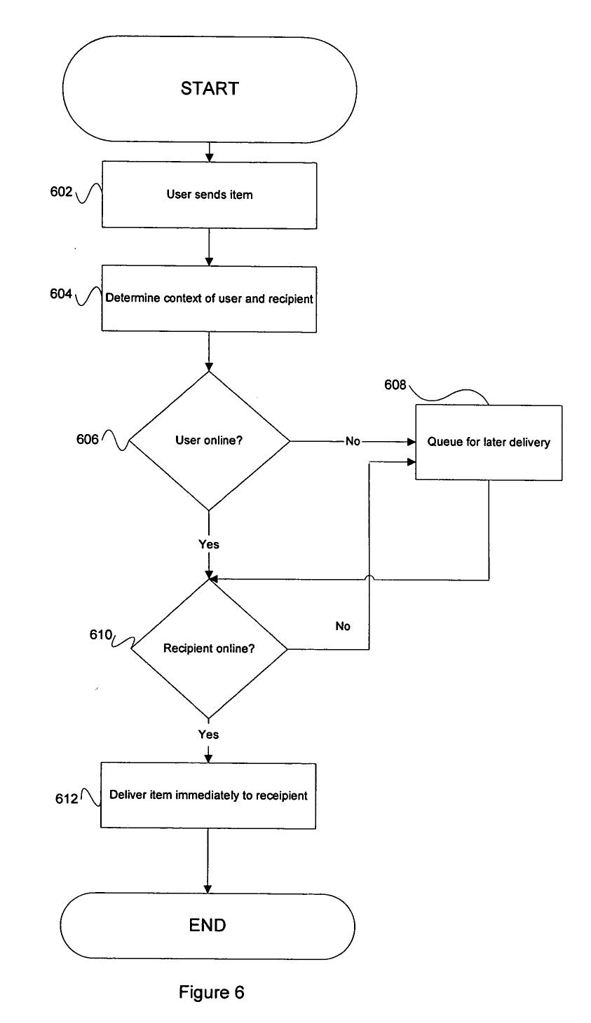

FIG. 6 depicts the steps in an exemplary method for sending data such as files, questions, answers, quizzes, etc., synchronously or asynchronously using presence awareness. First, the user sends the data (step 602). Then, the system determines the context of the user and the recipient, i.e., determines if they are online and present on the system (step 604). If the sending user is offline (operating asynchronously) (step 606), then the data is queued for later delivery when the sending user becomes online (operating synchronously) (step 608). If the sending user is online and the recipient is offline (step 612), the data is queued for later delivery when the recipient goes online (step 608). If both the sending user and the recipient are online, then the data may be delivered immediately (step 612).

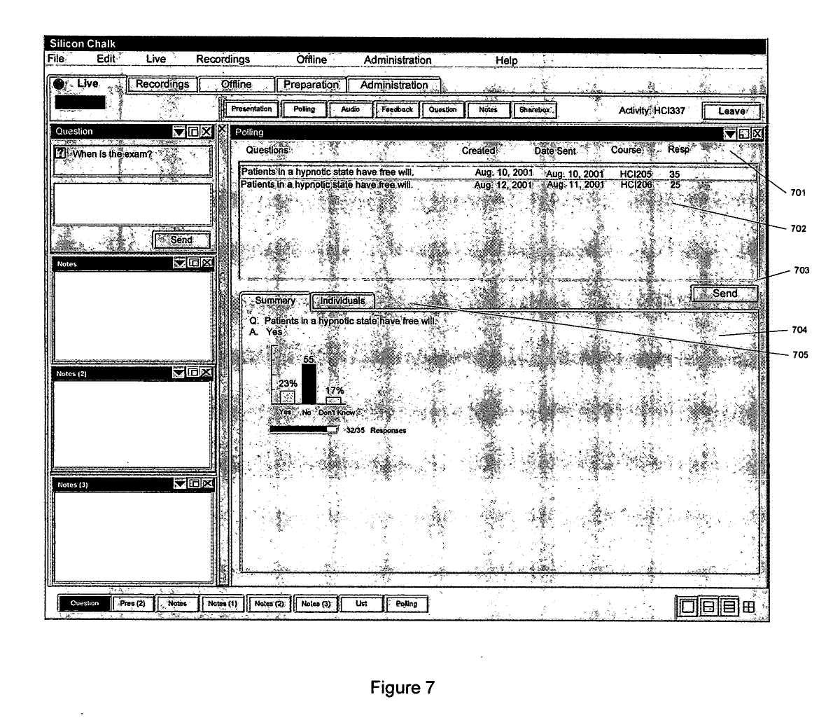

FIG. 7 depicts an exemplary graphical user interface provided to instructors 101 using the Polling feature of the exemplary system shown in FIG. 3. The Polling tool can be started by selecting a Polling button from the live tool button bar 405. In one implementation, the Polling tool has two versions depending on the role of the user. The instructor version of the tool operates on the instructor's computer 102 using the graphical user interface shown in FIG. 7. The student version (not shown) is basically the same as the instructor version but with the ability to respond to sent questions instead of creating them.

An instructor 101 can create new questions to send to participants of an activity by selecting one of the options in a pull down menu 701. Different types of polling questions can be created including, for example: (1) open ended, (2) yes/no/do not know, (3) agree/disagree and (4) multiple choice questions. The questions may be either saved or sent to participants of an activity. Other options 701 may include the ability to copy, or delete existing questions and display the summary of the results to all participants. A quick send button 703 is provided for instructors 101 to quickly send the question to all participants of a live session. For the student's version of the tool, this send button returns the answer to the instructor 101. Instructors 101 may have the option to select specific students 103, 105 to send polling questions. A summary list of polling questions 702 shows saved and sent questions. For questions sent during a live session, the results are displayed when the question is selected 704. Results of polling questions are displayed as a histogram or as a list of answers for open-ended questions. Instructors 101 can also view responses from individual users by selecting the Individuals folder 705.

Instructors 101 can access the same list of polling questions and results that are displayed during a live session during off-line mode (asynchronous). Instructors 101 can create, copy, view, and edit polling questions outside of a live class to prepare questions in advance of the live session using the same graphical user interface used during a live session (FIG. 7). In one exemplary implementation, a difference from a live session is that polling questions may not be sent immediately. Instead, they may be saved for later when an instructor 101 can select the question and send them at the appropriate time during the live session. Other modes are also possible such that questions may be delivered when a user is available to receive them; in this case, delivery may be deferred until the recipient is available. The Polling tool achieves its blending of synchronous and asynchronous behavior by using the same underlying presence aware message delivery system as the Sharebox 501. FIG. 6 depicts exemplary steps in an exemplary method consistent with the sending of polling questions synchronously or asynchronously. An exemplary queuing and delivery mechanism (Messenger) used by the Polling tool is discussed further with regard to FIG. 14 for the live mode 1415 and for the playback mode 1418. Exemplary implementation techniques used for the polling tool in live 1407 and playback 1408 are discussed further with regard to FIG. 14.

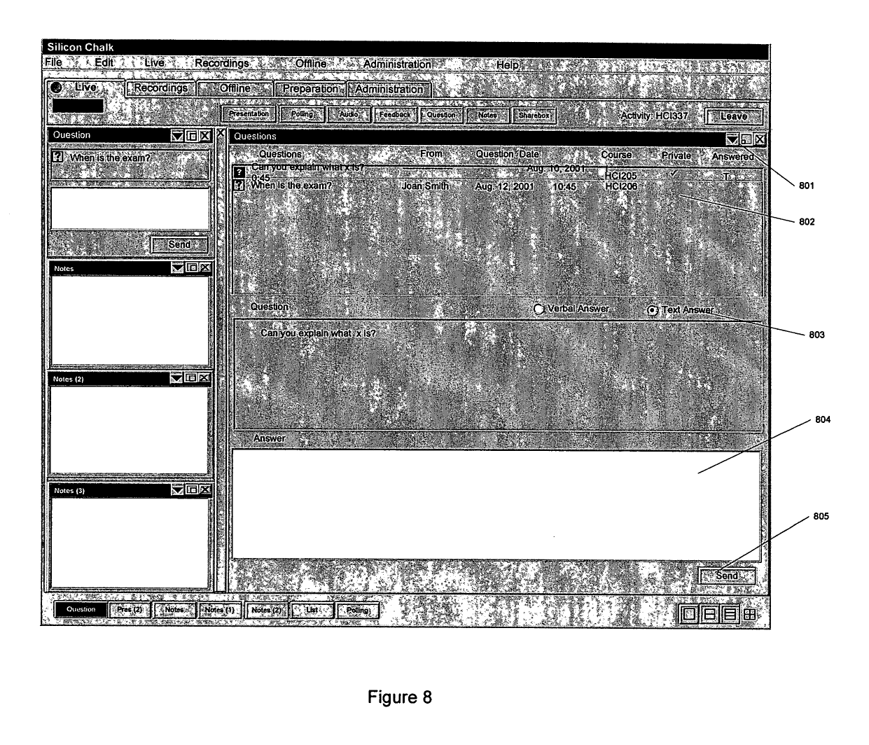

FIG. 8 depicts an exemplary graphical user interface provided to instructors 101 using the Question feature of the software shown in FIG. 3. This tool allows the instructor 101 to answer student questions sent to them using the same tool. The Question tool can be started by selecting a Question button from a live tool button bar 405. An exemplary student version of the tool (not shown) has the same functions except that students 103, 105 can ask questions and send them directly to the instructor 101. This student question tool is designed to provide participants with a quick way to send questions to instructors 101, who are notified when there are new questions. Users can select from a list of options 801, for example, to select individuals to send messages to, to unmark highlighted questions, and to set the level of privacy and anonymity. Questions are displayed with summary information in a question summary list 802. An instructor 101 has the option of responding and marking the question as verbal or textual 803 either during the session or later after the live session is over. The answer may be directly entered by an instructor 101 in the Answer text display 804 and sent to all participants by selecting the send button 805, unless the question is marked as private by a student in which case the answer is sent only to the individual.

Users can access the same questions and answers that are displayed during a live session during off-line mode (asynchronous) using the same exemplary graphical user interface displayed in FIG. 8. Instructors 101 may review and answer questions outside of a live class. For example, after the class is over, an instructor 101 can review questions sent during the class and answer them in preparation for the next class. One exemplary difference from a live session is that questions and answers are not sent unless users are logged in and have joined a live session. The Question tool achieves its blending of synchronous and asynchronous behaviour by using the same underlying presence aware message delivery system as the Sharebox 501. FIG. 6 depicts exemplary steps in an exemplary method consistent with the sending of questions and answers synchronously or asynchronously. An exemplary queuing and delivery mechanism used by the question tool is discussed further with regard to FIG. 14 for the live mode 1415 and for the playback mode 1418. Exemplary implementation techniques used for the question tool in live 1407 and playback 1408 are discussed further with regard to FIG. 14.

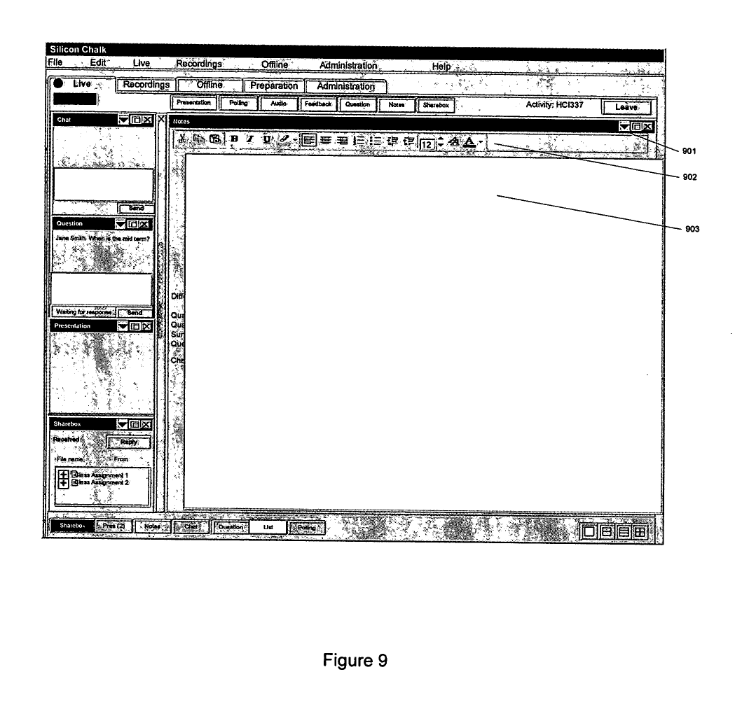

FIG. 9 depicts an exemplary graphical user interface of the note taking feature of the system shown in FIG. 3. The Notes tool can be started by selecting a Notes button from the live tool button bar 405 and can be used to create a text document to be added to a recording for note taking. Notes added during a live session are recorded and saved as part of the whole session recording. Users can select options 901, for example, to rename, print, or import Notes. Users may have access to common editing functions 902 while using the notes tool such as copying, pasting, finding, justifying, replacing, indenting, bulleting and highlighting text. Users can enter text using their keyboard directly into the notes window 903, or may enter notes via other text entry techniques (e.g., voice recognition dictating software, handwriting transcription software). Similarly, annotations (not shown) may be added to images. Embellishments such as notes and annotations are kept in the context of the original session. Annotations are directly associated with the particular image, and notes are located within the context of the lecture material. For example, if notes were taken during a presentation broadcast with audio, these notes will be associated with the presentation and the audio in the correct time and space that they were added. The text is recorded as a part of the integrated multi-stream recording of the live session that is saved on each computer 102, 104 and 106 in the recordings component 303 of the exemplary system. When the recording is played back, the notes may appear at the same point in time they were added.

The exemplary note-taking tool is another tool that is accessible in either synchronous or asynchronous mode. Users may use the same exemplary graphical user interface (as shown in FIG. 9) to access and edit notes whether they are in a live in-class session or off-line. The blending of synchronous and asynchronous sessions enables users to take notes during a live session and to edit them after the session is over using the same note-taking tool. The exemplary system allows users to edit notes during playback of the recording. During playback, the user can simply select a text box of the Notes tool. The exemplary system pauses the recording, enters edit mode and editing changes can be made directly into the playback notes. After making changes, the user can return to playback mode and continue to review the recording. These changes are made within the context of the original lecture material. For example, if notes were taken during a presentation broadcast with audio and these notes are changed in playback, the changes will still be associated with the presentation and the audio in the correct time and space. All the changes that are made to notes or presentation broadcast annotations may be saved as part of the integrated recording. Users may also edit their notes as a separate document independent of the recording if they wish. Exemplary implementation techniques used for the Notes tool in live 1407 and playback 1408 are discussed further with regard to FIG. 14.

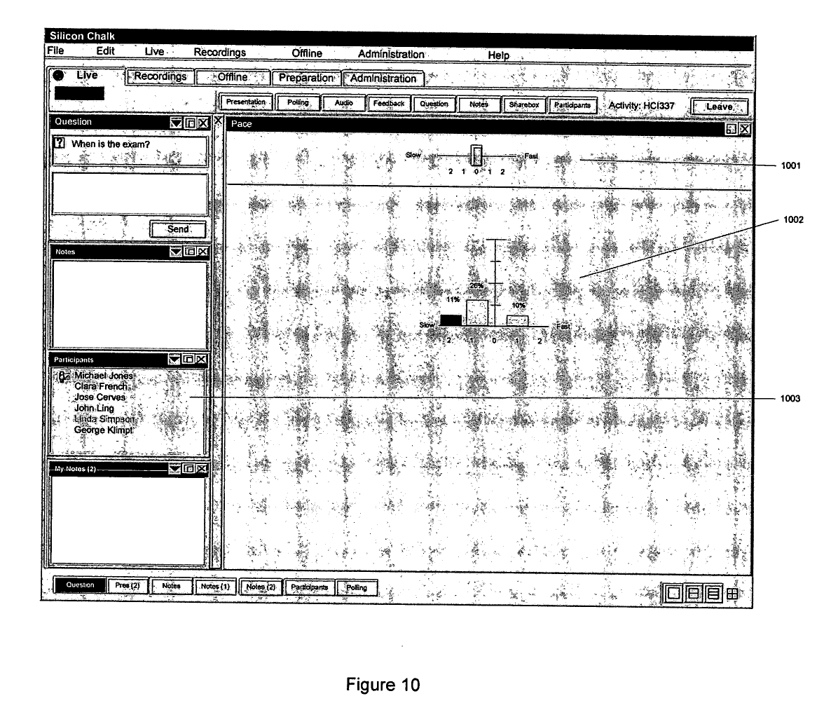

FIG. 10 depicts an exemplary graphical user interface of an exemplary feedback feature of the exemplary system shown in FIG. 3. In one implementation, there are two exemplary feedback tools: one provides students 103, 105 with a method of indicating their level of understanding of the material and the other provides a method for indicating the pace of the presentation. The feedback tools may be started by selecting the Comprehension or Pace buttons from the live tool button bar 405. The Comprehension and Pace tools are similar in function; they allow participants to provide immediate anonymous feedback to the instructor 101. Participants are provided with a software slider to indicate their comprehension of the lecture material or their perception of the pace of the lecture on a sliding scale. In one implementation, all participants can view real-time displays that graph the results of participant's responses and these responses may be color coded to indicate severity. Instructors 101 can monitor the graphs and adjust their presentation style depending on the input from participants.

FIG. 10 shows an exemplary student's version of the Pace feedback tool. An exemplary instructor's version 101 of the tool may be the same except that instructors do not have the slider control. The exemplary students' version has a slider 1001 to allow students 103, 105 to indicate their feedback. The summary display 1002 may be immediately updated to show the aggregate of all the responses from students 103,105. Thus, an instructor 101 can view a graph of the level of understanding or pace that students 103, 105 have entered. Another feature of the feedback tool is that a participant's response may revert back to a neutral response after a set time period. This may provide an advantage to students by not having to reset their response slider when their perceptions have changed. The exemplary feedback tools may have no off-line component but they may be recorded as part of the live session. Exemplary implementation techniques used for the feedback tools in live 1407 and playback 1408 discussed further with regard to FIG. 14.

FIG. 10 additionally depicts an exemplary graphical user interface of an exemplary Participant List of the exemplary system shown in FIG. 3. This tool can be started by selecting a Participant button from the live tool button bar 405. When a user selects the Participant button, a list of all the participants in an activity may be displayed 1003. This list may display who is currently joined in the activity, who the instructors 101 are and who is registered for the activity but not participating in a live session. Profile information may be accessed from the participant list. An exemplary implementation of the participation tool during live 1407 and playback 1408 is discussed further with regard to FIG. 14. Real-time participant data may be stored in the directory 1414.

Another feature identified in the Tools component 301 of FIG. 3 is the Audio tool. The exemplary graphical user interface for this tool is not shown in a separate figure since it may simply be an on/off toggle button presented along with other tools in the live tool button bar 405. In one implementation, this Audio tool initiates the broadcast of the audio track to all participants and the recording of the audio track on their own machine as part of the integrated recording. When an instructor 101 broadcasts the audio, students receive notification that audio is available. Students may have the option of selecting the audio button on their display to automatically record the audio broadcast as part of their own recording. Students participating in a live session either in-class 103 or from a distance 105 can select audio to hear the audio track of an instructor 101. The audio track is integrated as part of the complete recording and can be listened to during playback of the recording.

Another feature identified in the Tools component 301 of FIG. 3 is an exemplary Quiz tool. The Quiz tool allows instructors 101 to create and distribute, grade and view quizzes. Participants can complete quizzes distributed by an instructor 101 and submit them. The exemplary system may automatically grade participant answers on submitted quizzes using the values entered by the instructor 101 when quiz questions were created. The instructor 101 may also manually grade and edit answers and release the grades to participants. Instructors 101 can view reports with statistics and summary graphs for each quiz and participant.

An instructor 101 using the quiz tool is, for example, able to: (1) create a quiz, (2) create quiz questions, (3) move or remove quizzes or questions, (4) edits, (5) distribute, (6) view and (7) grade quizzes. Creating a quiz produces a template version of a quiz. A template enables users to copy instances of the quiz template and distribute these instances multiple times. Each quiz may be saved in a quiz database.

Users can create quiz questions of different types including, for example, pre-defined multiple choice, user defined multiple choice and long answer questions. Values may be assigned to questions when they are created. These values may be used by the exemplary system to automatically grade questions and sum the scores when quizzes are submitted by participants. Quiz questions can be created and directly added to a specific quiz or saved to a question database. The quiz question database may be used to store all created questions. Users can create question categories with category values and enter these properties as part of the question. These categories can be used to search and identify questions in the question database when assigning questions to quizzes.

Users may also move the location of a question within a quiz or remove questions from a quiz. Users can also remove questions from the question database. Once a quiz has been created, users can edit the quiz to change properties of the quiz such as instructions, comments, questions and grading schemes.

An instructor 101 can distribute quizzes to all participants of an activity. The exemplary system may send a copy of the quiz to each participant and indicates to the instructor when each participant receives the quiz. The instructor 101 can choose delivery options when distributing quizzes. These options may include the ability to set a quiz password, release the answer key on submission, allow participants to save and resume, allow anonymous submission and automatically grade a quiz when it is submitted. Users can preview quizzes before they have been distributed and view quizzes that have been distributed and submitted by participants. In one implementation, a quiz progresses through states including: inactive, distributed, received, in progress, unsubmitted, submitted, not graded, graded, and grades released.

Submitted quizzes may be automatically graded by the exemplary system based on assigned scores. Instructors 101 can manually grade answers, edit assigned values and scores on questions and update the total grade based on these manual entries. Users can release grades to participants. When grades are released, the exemplary system sends grades to each of the participants that submitted a quiz.

The exemplary system may display summary statistics for completed quizzes. Statistics may include quiz means, standard deviations, median, minimum, maximum and number of participants. The user can choose to view a graph of the statistics or view the summary statistics by participant.

A student using the quiz tool may, for example: (1) start, (2) submit or (3) view quizzes. Distributed quizzes can be started by participants. While taking a quiz, all answers entered by the student may be saved on the student's machine and sent to the instructor 101. When a quiz is submitted, the quiz is saved and sent to the instructor 101. When quizzes are distributed by an instructor 101, the student can view the quiz. Once it has been submitted, the student 103, 105 can also view the quiz with their answers. If the answer key and grades are released by the instructor 101, then participants can view these as well.

In one implementation, all the functions of the quiz tool which are available during a live session may also available during off-line mode (asynchronous mode). For example, this allows instructors 101 to create quizzes outside of a live session and allows students 103, 105 to take quizzes outside of a live session. One exemplary difference from a live session is that the sending of quizzes (either distributing or submitting them) off-line does not occur until users are logged in and joined in a live session. The Quiz tool achieves its blending of synchronous and asynchronous behaviour by using the same underlying exemplary presence aware message delivery system as the Sharebox 501. FIG. 6 depicts exemplary steps in an exemplary method consistent with the sending of quizzes synchronously and asynchronously. An exemplary queuing and delivery mechanism (Messenger) used by the quiz tool to distribute and submit quizzes is discussed further with regard to FIG. 14 for the live mode 1415 and for the playback mode 1412. Exemplary implementation techniques used for the exemplary quiz tool in live 1407 and playback 1408 are discussed further with regard to FIG. 14.

Another exemplary feature identified in the Tools component of FIG. 3 is the Chat tool. The exemplary Chat tool enables users to create a chat session and invite others to the session during a live session. When the invitation is sent, the exemplary system provides the recipient with the option of accepting the invitation. Participants can accept invitations which allows them to view and exchange text messages in real time. Users can set their own status to unavailable. If users are unavailable, then the exemplary system does not allow other participants to invite them to chat sessions. The exemplary system displays a list of participants for each session and whether they are available and invited. In one implementation, instructors 101 have the option to automatically listen in on chat sessions. When this option is selected, the exemplary system automatically enters the instructors 101 as invited participants to all chat sessions. Additionally, users may create multiple chat sessions and invite different participants to each of them.

Another feature identified in the exemplary Tools component 301 of FIG. 3 is the exemplary Class Management tool. The Class Management tool enables instructors 101 to control the external applications used by participants during a live session. The exemplary system may monitor the applications that are opened by participants in a live session. Instructors 101 can specify which applications are allowed and which ones are forbidden during a live session. When the exemplary Class Management feature is in effect, users may be notified, and the exemplary system prevents students 103, 105 from opening applications that are designated as forbidden. If a student 103, 105 joins a live session while a forbidden application is running, the exemplary system may shut down the forbidden application. The exemplary system monitors participant machines and displays a list of open applications. This list displays whether the application is forbidden and whether class management control is in effect on each of the participant machines. The exemplary system also saves a list of all the applications opened by participants and appends to this list new applications opened by participants. This list is used by the instructor 101 to specify which applications are allowed or forbidden. The instructor 101 may have the option of designating newly opened applications as allowed or forbidden.

The exemplary class management takes effect during a live session but the ability to set up the class management functions are available in off-line mode (asynchronous mode) as well as in a live session. This allows instructors 101 to create a class management policy by deciding which applications will be allowed and forbidden off-line. They can also select an option to set the class management tool to take effect automatically during a live session. One exemplary difference from a live session is that the exemplary class management policy will not take effect until users are logged in and joined in a live session. The exemplary class management tool achieves its blending of synchronous and asynchronous behavior by using the same underlying presence aware message delivery system as the Sharebox 501. FIG. 6 depicts exemplary steps of an exemplary method consistent with setting class management functions synchronously or asynchronously. An exemplary queuing and delivery mechanism (Messenger) used by the exemplary class management tool to transmit class management information is discussed further with regard to FIG. 14 for the live mode 1415 and for the playback mode 1418. Exemplary implementation techniques used for the class management tool in live 1407 and playback 1408 are discussed further with regard to FIG. 14.

Another exemplary feature identified in the exemplary Tools component 301 of FIG. 3 is an exemplary Research tool. This tool provides brainstorming features that allow users to generate and organize ideas in a collaborative environment. Projects can be created and participants can be assigned as project members to give them access and edit privileges. Projects are used as collaboration spaces to add and organize research topics. Each topic has an associated window that allows members to add information including text, images, and files. Items from outside applications can be dragged and dropped or copied and pasted to topic areas. Users have access to common editing functions when adding text to the Research tool including, for example, copy, paste, find, justify, replace, indent, bullet and highlight text. An outlining function allows users to move items up and down within a topic area or to different levels within a hierarchy. The outlining feature can also be applied to topics to move around and prioritize headings. Members can be assigned different colors and the exemplary system will display text in the assigned color to help differentiate the source of information on the display. During a live session, members can view and edit information added by other members. Members can add, edit and delete projects, topics, text and contained information such as files.

The exemplary Research tool is available in off-line mode (asynchronous mode) as well as in a live session. Individuals can use the exemplary Research tool to work on material on their own outside of a live session. During off-line mode, in one implementation, the exemplary collaborative functions are not available. As a result, information will not be sent or received until users are logged in and joined in a live session. When opening the exemplary Research tool during a live session, the exemplary system detects whether there are differences in the information stored in each of the member's exemplary Research tools. Users are provided the option of sharing information with others and synchronizing with the shared Research tool information or keeping their own information separate. The Research tool achieves its blending of synchronous and asynchronous behavior by using the same underlying presence aware message delivery system (Messenger) as the Sharebox 501. FIG. 6 depicts exemplary steps of an exemplary method for sharing research synchronously or asynchronously. An exemplary queuing and delivery mechanism used by the Research tool to share information is discussed further with regard to FIG. 14 for the live mode 1410 and for the playback mode 1412. Exemplary implementation techniques used for the research tool in live 1407 and playback 1408 are discussed further with regard to FIG. 14.

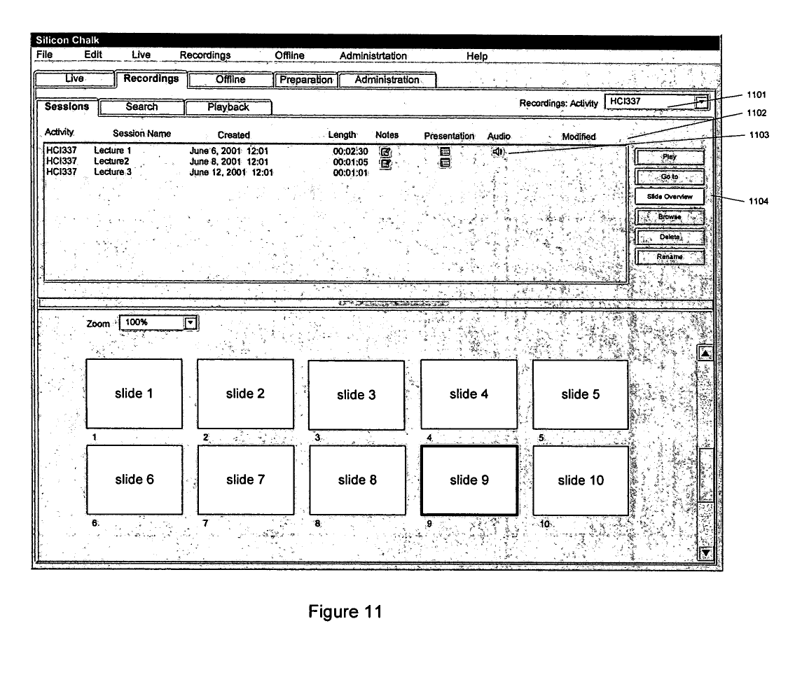

FIG. 11 depicts an exemplary graphical user interface for selecting recorded sessions identified in FIG. 3. Users can select the activity from a list 1101 to narrow the display of recorded sessions in the summary display 1102. The summary display 1102 provides an indication of whether different streams 1103 of information from various tools are present in the recording. A preview 1104 of slides or bitmaps displays an overview of images in the recording. Users may play a selected recording or go to a selected slide within the recording. Other exemplary options include the ability to delete specific recordings, rename a recording or retrieve files from a different location. Recorded sessions are stored on disk via the Nexus 1413, 1417 and are discussed further with regard to FIGS. 14, 16, 17, and 18.

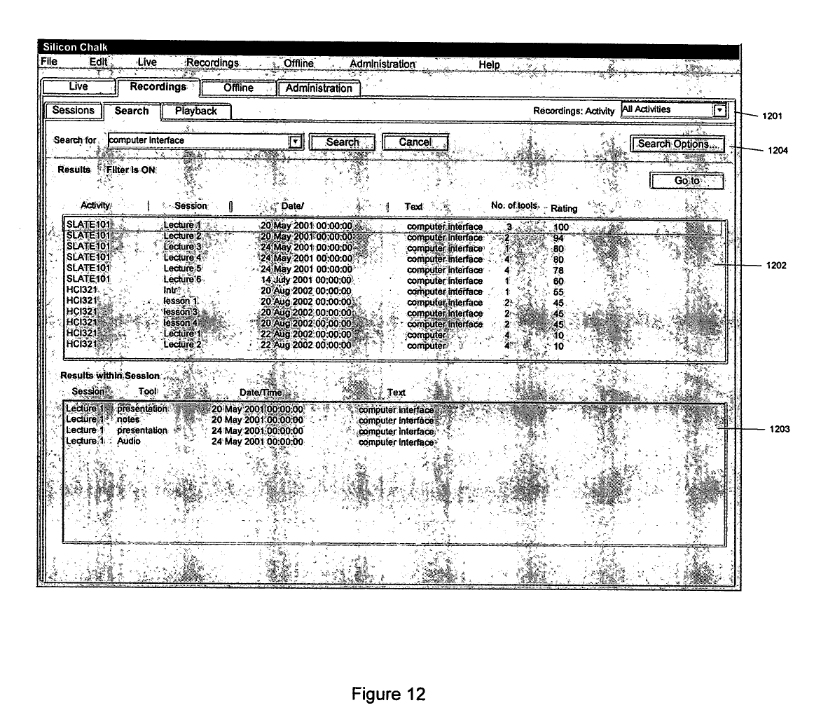

FIG. 12 depicts an exemplary graphical user interface generated by the exemplary system for a multi-stream search identified as one of the functions 303 in FIG. 3. Users can select the activity from a list 1201 to narrow the display of recorded sessions in the summary display 1202. The summary display 1202 provides users with an indication of the activities that contain the searched text. A more detailed view 1203 shows the individual hits within a session when one of the activities is selected. This view 1203 identifies the information stream that resulted in the hit and provides a simple and informative list of searched items across a multi-stream recording. Users can go directly to an item within the recording by selecting from the detailed list. Exemplary options available to the user include the ability to filter the search to display results only in selected tools and to define the search parameters 1204. The list of recordings is stored and supported by the Nexus 1413, 1417 which is discussed further with regard to FIGS. 14-18.

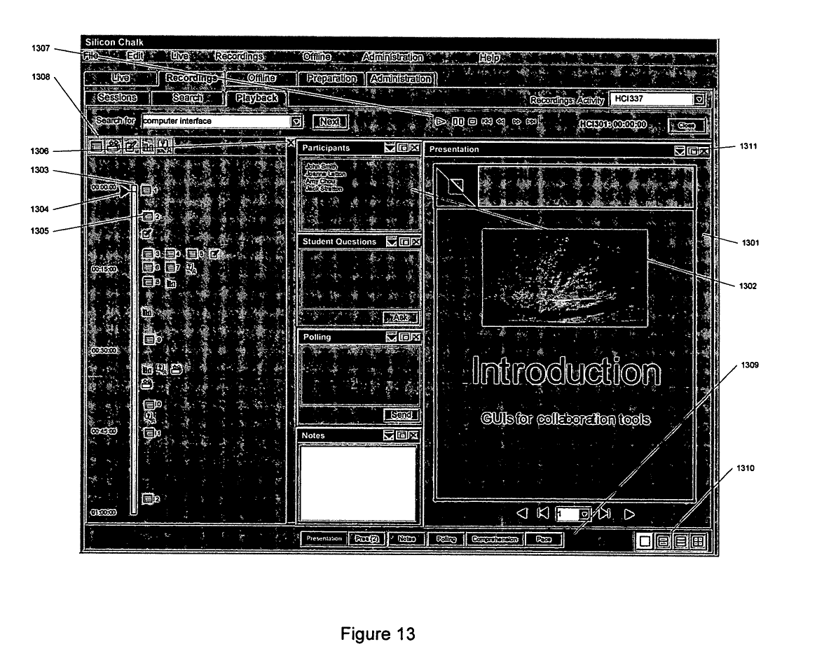

FIG. 13 depicts an exemplary graphical user interface generated by the exemplary system for controlling the playback 303 of multi-stream recordings as identified in FIG. 3. When a user has selected and played a session or searched for text within a session, the playback window displays the recording and starts playing back the recording. In one implementation, the recording is displayed as it was recorded during the live session with main 1301 and mini views 1302. In addition to the playback of the actual recording, an overview of the recording is provided by a graphic timeline 1303 with timestamps at regular intervals. The display of the timeline 1303 may be adjusted automatically to use the full length of the screen regardless of the time length of the recording. A control handle 1304 indicates the current location in the recording along the timeline 1303. Moving the handle 1304 with the mouse cursor, for example, provides a means to navigate through the recording.

Along the timeline 1303 are visual representations, e.g., icons 1305, of significant events that occurred during the recording of the live session. These icons represent events from multiple streams of information recorded from each of the tools during the live session. They may include, but are not limited to: (1) presentation events, (2) user-generated events, (3) notes events, (4) shared file events, (5) polling events, (6) question events, and (7) audio events. Presentation events include slide transitions in a presentation. The slide numbers and titles are displayed when the mouse is hovered over the icon. User generated events are events created by users. During a live session, users can create events as markers. These events trigger new slides that are displayed in the recording. As a result, the playback display shows an icon for these events. During a live session users, can create events through the use of keyboard short-cuts, buttons, menu-entries or other appropriate input mechanisms. During playback these events are displayed in the same manner, although with unique icons, as the events generated by the tools. An example of a user-generated event might be the user clicking on an “Important Point” button on the user interface. This allows the user to mark that point in the live session as one where something important was said or done. This allows the user to easily return to that point during playback.

Notes events include comments that were added to a presentation during a live session are recorded as events and displayed as icons 1305 along the timeline 1303. Shared file events represent the sharing of files. During a live session, participants can collaborate by sharing documents, editing and sending them to other users. Each time a document is sent or retrieved, an event is recorded and displayed as an icon 1305. The name of the document may appear when the mouse cursor is hovered over the icon 1305. Polling events are represented by icons 1305 are displayed along the timeline 1303 representing when the Polling tool was used to survey participants during a live session. Question events are represented by icons 1305 that are displayed along the timeline 1303 when questions are asked or answered using the Question tool during a live session. Audio events are recorded and displayed along the timeline 1303 when the audio is turned on or off.

Users can determine the type of event and approximate time that it took place within the session by looking at the timeline 1303. Users can select the corresponding icon 1305 to go directly to a specific event in the recording. The timeline handle 1304 jumps to the appropriate location on the timeline 1303 when an icon 1305 or another point on the timeline 1303 is selected. This function provides quick and easy access to multiple events from different streams of information that were recorded during the live session.

The timeline view can be minimized with a click of the mouse 1306, opened to a default size and changed in size by dragging the window edges with the mouse cursor. Users can use the control buttons 1307 to fast forward, go to the beginning or end, play and pause the recording to navigate through the recording. An exemplary filter mechanism provides users with the ability to display selected streams of information along the timeline 1303 by toggling buttons 1308 representing different streams of information. The streams that can be filtered may include, but are not limited to, the presentation, notes, document sharing, polling, audio, and student questions.

An advantage of the exemplary system is the ability to interact with recorded information during playback. Users can interact with recordings by changing the layout of information displayed during playback or by using the tools that were started or available during the live session. In one implementation, display events such as minimize, maximize, and moving windows around on the screen are not recorded during the live session. As a result, users can control the position of tools by minimizing, maximizing and moving tools around during playback regardless of their original location during the live session by using the same layout control functions that are available during live sessions. These controls may include, for example, the use of the task bar button 1309, drag and drop to move tools, the multi-panel main view controls 1310 and minimize and maximize controls 1311.

Users may also interact with the recording during playback by using the tools displayed in the exemplary playback view 1301, 1302. This includes, but is not limited to, the ability to access and use Sharebox items (FIG. 5), create polling questions (FIG. 7), ask and answer questions (FIG. 8) and edit notes (FIG. 9). The ability to change layout and use tools during playback provides an advantage over conventional systems at least by blending the distinction between synchronous and asynchronous sessions. Another advantage is that users can interact with the recordings by moving tools, editing notes, viewing and accessing different aspects of the information within the context of the whole recording. The same tools, operations and graphical user interface can be used whether users are in a live session, off-line or playing back the recording.

FIG. 14 depicts exemplary relationships between the graphical user interface and the exemplary architecture of the exemplary system that supports the exemplary functions discussed with regard to FIG. 3. A top window 1401 is a container that supports the Live visual components 1402 or the Playback visual components 1403. When live, the exemplary Main Window 1404 includes the user interface elements 1407 for each of the tools. The behavior of these tools was previously discussed above with regard to FIGS. 3-10. Each of these tool user interfaces 1407 is supported by their corresponding tool infrastructure 1410. Live tools 1410 are connected to the underlying subsystems, including: Nexus 1413, Directory 1414, Messenger 1415 and User Data 1416.

During playback of a recording, the top window 1401 includes the Visual components 1403. The Playback window 1405 contains playback controls and a Main Window 1406, which in turn includes user interface elements 1408 for each of the tools. Further description of activities supported during playback was previously discussed above with regard to FIGS. 13, 14 and 16 Each of these tool user interfaces 1408 is supported by their corresponding tool infrastructure 1412. Tools 1412 in playback are connected to the underlying structures, including: Nexus 1417, Directory 1420, Messenger 1418 and User Data 1419.

The Main Window 1404 provides a uniform visual framework that supports all Tool user interfaces 1407, 1408 in the application. The Main Window 1404 provides the basic user navigation capabilities of the application including, for example: (1) the ability to move tool windows from one display frame to another, (2) the ability to create and associate a new icon with a tool window, (3) uniform handling of tool menus, (4) uniform handling of the closing of tool windows, (5) re-sizing of tool windows and (6) the ability to choose different screen layouts.

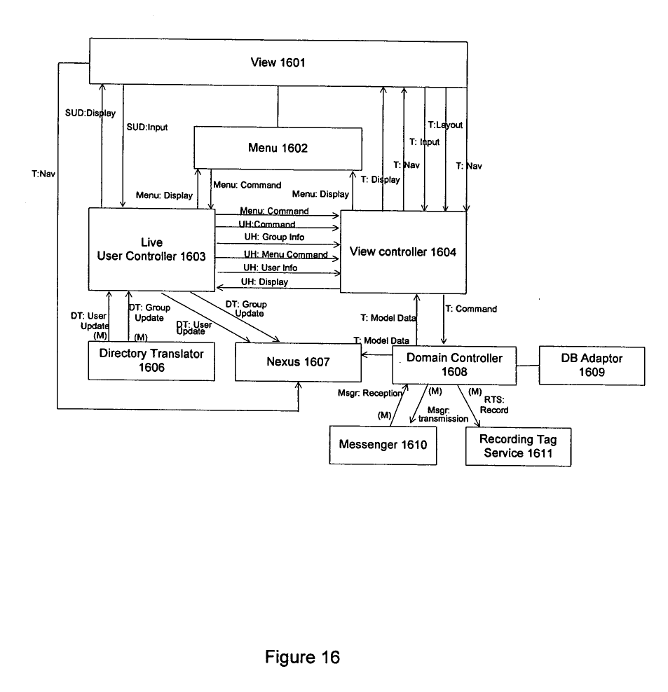

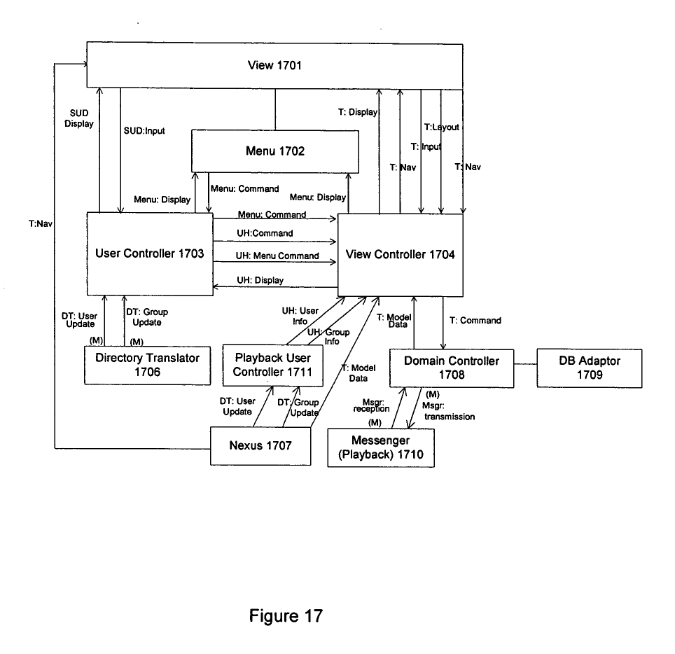

The separation of each tool into separate user interface 1402, 1403 and infrastructure components 1409, 1411 assists in achieving the type of interactive playback that is supported by the exemplary system. This exemplary structure is discussed further with regard to FIGS. 16-17. The Nexus 1413 is the exemplary subsystem that provides recording and playback of event streams, and is discussed further with regard to FIG. 18.

During a live session, the various components of the applications communicate to one another through the exchange of typed events. The configuration and nature of these events, their types and interactions are discussed further below with regard to FIG. 16. A subset of these events (also described in FIG. 16) is sent to the Nexus 1413 to be recorded. Prior to delivery to the Nexus 1413, typed events are translated into a generic binary format. This translation is carried out automatically by components referred to as “marshallers,” which in their general sense, are components generally known in the art. These marshallers are generated automatically from the Event Specification Language (“ESL”) (both discussed further with regard to FIG. 16). In one implementation, the Nexus 1413 is thus unaware of any application-specific meaning of the events it receives.

The Directory 1414 is a peer-to-peer replicated data-store. It helps enable the synchronous and asynchronous operation of the exemplary application by providing information about whether other users are participating in a session. The Directory 1414 is discussed further in a related U.S. patent application Ser. No. ______ entitled, “Method and System for Synchronizing Data in Peer to Peer Networking Environments,” which was previously incorporated herein.

The Messenger 1415 is a general-purpose reliable message delivery service. The Polling tool, Sharebox 501, and Question tool are examples of tools which may use the Messenger 1415 as their primary communication mechanism. The Messenger 1415 helps enable the ability to transition smoothly between synchronous and asynchronous modes. The Messenger 1415 makes use of presence information obtained from the Directory 1414 to determine whether data should be immediately sent to a participant (synchronous), or whether it should be queued for later delivery (asynchronous). The presence information obtained from the Directory 1414 indicates whether the targeted user is currently online and in an appropriate state for receiving messages. Messages may also be relayed through an intermediary instance of the Messenger 1415 that can then hold them for delivery until the targeted user is available.

Like the Nexus 1413, the Messenger 1415 may work with events in a generic binary form. In one implementation, the Messenger 1415 is not aware of any tool-specific semantics of the data that it handles. An exemplary internal structure of the Messenger 1415 includes a set of queues of messages waiting to be delivered to tool components on other machines. Message delivery may be specified by tool and user. Thus, a given message will be delivered to a specific tool being used by a particular user. Reliable delivery of messages is achieved using a standard acknowledgement/timeout protocol.

The Messenger 1415 helps enable the smooth transition between synchronous and asynchronous behaviour through its ability to queue messages for later delivery and its active monitoring for whether participants are on-line. If the user interacts with a Messenger-based tool while they are on-line, then the Messenger 1415 will attempt to deliver those messages immediately (synchronous). If however, the user is off-line, or the intended receiver is off-line, the Messenger 1415 will queue the message until it receives a notification that the intended recipient is online (asynchronous). Online may refer to a user that is participating in a live session on the network or multicast group. It may also refer to a user that is connected to a common network as another user who may also be using the application. The tool components do not have to change their interaction with the Messenger 1415 in order to achieve this transition whereas it is internal to the Messenger itself.

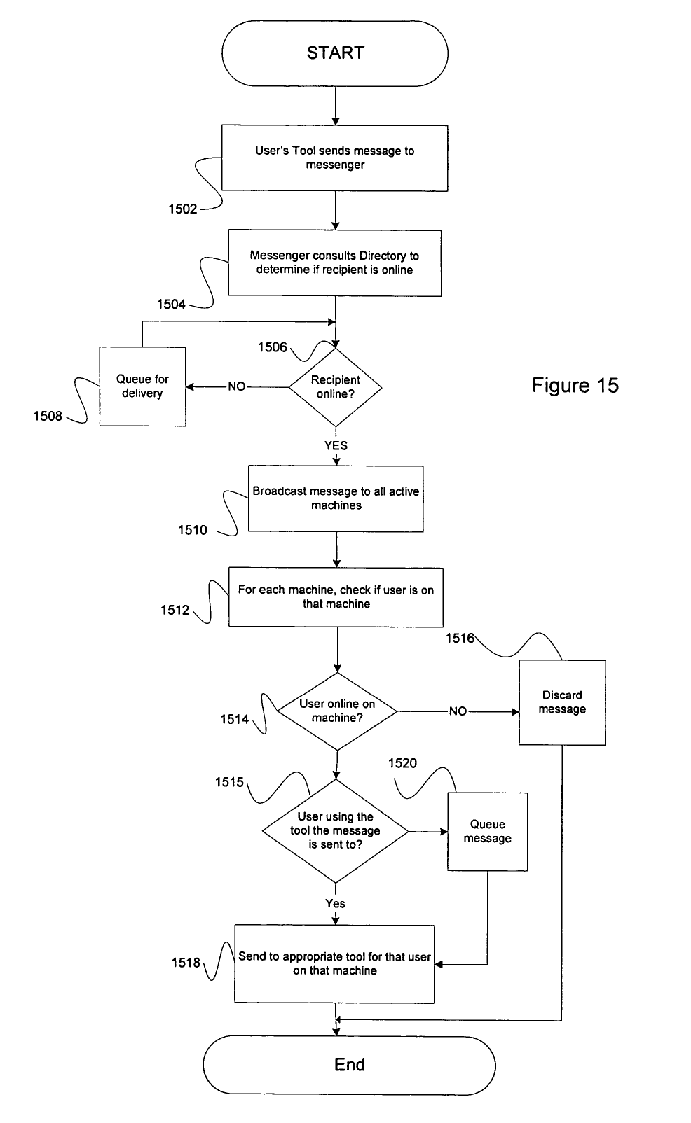

FIG. 15 shows exemplary steps in an exemplary method for message delivery by the Messenger 1415. When a message is first given to the Messenger 1415 for delivery to a particular tool and user (step 1502), the Messenger on the sending machine consults the Directory 1414 to determine if that user is currently online (step 1504). If the user is not online (step 1506), the message is queued for later delivery (step 1508). If the user is online (step 1506), in one implementation, the message is broadcast on the network and received by the Messenger 1415 component on all other machines within the network (step 1510). Each of these Messengers 1415 examines the message (step 1512) to determine whether the user it is being sent to is currently active on that machine (step 1514) and whether the target tool is running (step 1515). If so, the message will be delivered to a particular tool component on that machine (step 1518). If the user is signed on but the tool is not running, the Messenger 1415 queues that message for attempted delivery in the future (step 1520). If the user is not signed on to that machine, the message is discarded (step 1516). As with the Nexus 1413, just prior to an event being delivered to the tool component, it is translated from the generic binary format to the tool specific format utilized by the tool.

The Messenger 1415 also incorporates a dynamic bandwidth adjustment mechanism that adjusts the rate at which information is transmitted onto the network in response to changes in available bandwidth. This ensures that bulk data transfers carried out through the Messenger 1415 do not overwhelm the communications of the more real-time portions of the application. When a component delivers an event to the Messenger 1415 for delivery to another user or group of users, it may associate that message with a priority level such as low, medium, and high. The priority level controls how much of the available bandwidth the Messenger 1415 will use in attempting to delivery messages of that priority level. The Messenger 1415 periodically queries the network service to determine how much bandwidth is available and transmits messages to the network when it has not used up its bandwidth allocation.

The exemplary User Data component 1416 is an adapter to an underlying commercial database (not shown). It provides a uniform interface via which tools may store and retrieve data via standard SQL queries/statements. Tools may use the database to store application specific data. For example, the Question tool may use the database to store each question and answer. In one implementation, tools may store data for all interactions observed during a live session, not just those interactions that originate at a particular participant.

The right half of FIG. 14, which represents the architecture of the system during the playback of a recording, is similar to the left (which represents the architecture for participating in and recording a live session). Some exemplary differences between the two are that there is a different top-level visual component called the Playback window 1405 which includes visual elements for controlling playback (e.g., fast forward button, pause button, etc) as well as visual elements associated with searching recordings. Additionally, during a live session, event data is recorded to the Nexus 1417. During playback of a recording, this information flow is reversed and event data flows out of the Nexus 1417 and back into the tools.

Otherwise, the structure of the various components during a live session and during playback is similar. This similarity in structure is beneficial to achieving one of the exemplary advances represented by the exemplary system: that the user is able to manipulate the various user interface elements as though he were still in a live session.

To support user manipulation during playback, in one implementation the program logic that is present during the live session is also present at playback, and that program logic operates in a manner analogous to the way in which it operated during the live session. Because of the complexity inherent in each of the tools, one exemplary means of achieving this parallelism is to use the same components in both situations. This differs from conventional systems that typically use simplified components and structures during playback of recorded sessions.

FIG. 16 depicts an exemplary architecture of a single tool 1407, 1410 in live mode as shown in FIG. 14. In one implementation, all tools in the exemplary system have a similar basic structure. The view 1601, Menu 1602, User Controller 1603, View Controller 1604, Domain Controller 1608 and DB Adapter 1609 are private to this particular tool instance. The Directory Translator 1606, Nexus 1607, Messenger 1610 and Recording Tag Service 1611, in one implementation, are shared among all tool instances. Menu 1602 and DB Adapter 1609 which have instances that are private to this tool are, however, re-usable components that are not developed independently for each tool.

The components within a tool communicate primarily through the asynchronous exchange of typed events. The types of these events and the direction in which they flow are represented in FIG. 16 by directed arcs between the components. The contents of each event type may be contained within a XML event specification document. In this case, the XML language is referred to as the Event Specification Language (“ESL”). An event compiler (not shown) inputs these specifications and generates C++ code that defines each event, as well as a collection of utility routines that allow each event to be serialized/de-serialized to/from a format suitable for storage on disk or transmission over the network. The connections between the tool's components may be described by an XML configuration specification. A configuration compiler (not shown) takes these specifications and converts them into a series of database tables that are used at run-time by the application to automatically instantiate the tool's components and establish the event connections between them. Having formal specifications for both event types and event connections helps to reduce the amount of repetitive code that the developer must create and also reduces the likelihood or errors or inconsistencies during tool instantiation.

In addition, the configuration compiler is able to deduce where events need to be translated to and from generic binary forms such as, for example, when an event needs to be transmitted over the network. The configuration compiler automatically inserts marshallers/de-marshallers of the correct type into the event streams in the appropriate locations. For example, if the configuration specification indicated a connection from component A to the network, carrying events of type B, then the configuration compiler would insert into this connection a marshaller for type B events. During runtime, this marshaller would receive events of type B from component A, convert them into a generic binary form, and then pass them to the network.

In one implementation, each tool utilizes three exemplary components 1601, 1604, and 1608 that are unique to that tool. The other components 1601, 1604, and 1608 may be either shared or derived from common code. These three exemplary components are: (1) the View 1601, (2) the View Controller 1604, and (3) the Domain Controller 1608.

The View component 1601 is responsible for the display of user interface elements associated with the tool. In one implementation, the user interface does not encapsulate application logic but simply responds to commands that indicate what it should display, or provides indications of user interface activity (such as the user selecting a button on the tool). The View Controller 1604 maintains an internal model of what is being displayed by the View 1601. Events from the View 1601 or from the Domain controller 1608 may involve changes to what is displayed by the View. The View controller 1604 makes appropriate changes to its internal model and then issues events to the View 1601 to synchronize its internal model with what is actually displayed to the user. The Domain Controller 1608 executes the application logic specific to the particular tool. In one implementation, it also maintains all of the persistent data for the tool. The Domain Controller 1608 makes use of the DB Adapter 1609 to store and retrieve data from a relational database. The Domain Controller 1608 also receives events from instances of this particular tool that reside on other computers, and for some tools, receives events from the Messenger 1610. As modifications are made to persistent data, the Domain Controller 1608 sends events to the View Controller 1604, which in turn updates the View 1601 in order to show that information to the user.

Menu 1602 is a visual component responsible for drawing a tools drop-down menu. Live User Controller 1603 maintains information on which users are authorized participants for the current session, and whether they are currently joined to the session. Directory translator 1606 provides a semantic overlay on the underlying directory service. The directory translator 1606 understands the concepts of sessions, participants, roles and privileges. It translates to/from these application level constructs into the specific representations used in the directory 1414 to maintain and share information amongst different instances of the application. The Recording tag service 1611 is responsible for recording events that will be displayed on the timeline as bookmarks (or event icons).

The exemplary mechanism by which the various components relate to one another may be demonstrated by examining a particular interaction for a particular tool. The exemplary scenario examined is one in which the instructor 101 answers a question that has been posed via the Question tool (FIG. 8). The interaction begins on the instructor's machine when the instructor 101 types in an answer to a question that is displayed within the Question tool. The exact pattern of event interactions on the instructor's machine is not presented; the focus instead is on the activity at a typical student's machine.

The end result of the instructor's action at his computer 102 is that the Messenger 1610 on the instructor's computer sends out an event to all of the Messenger components on the students' machines. The Messenger 1610 sends a Reception event to the Domain Controller 1608. The Domain Controller 1608 inspects this event and determines that it is an answer to a previously posed question. The event contains a number that uniquely identifies the particular question being answered. The Domain Controller 1608 uses the identifier to locate the original question in the relational database via the DB Adapter 1609. It retrieves the question from the database and associates the answer with the question, writing the modified information back into the database. At the same time, it sends a Model Data event (described below) to the View Controller 1604.

The View Controller 1604 determines from its model of the display whether the answer text should be visible (that is, whether that particular question is currently being displayed by the user, and thus, whether the answer text should be shown). If the answer text should be displayed, then the View Controller 1604 sends a Layout message to the View 1601. The Layout message tells the View 1601 that it should now display the answer text in the appropriate region of the Question tool's user interface 804.

While the contents of the messages exchanged varies from tool to tool (for example, the Question tool exchanges events that contains questions and, optionally, answers, while the Sharebox 501 exchanges events that contain files), the structure and pattern of communications for the tools may be similar. The design and implementation of a new tool may begin with the generic exemplary tool architecture discussed with regard to FIG. 16, and proceed through a process of refinement to create a fully-realized tool. In one implementation, tools deployed in the exemplary system support the general event categories and types outlined below.

The design process for a particular tool may include creating a domain model (the underlying data and services which the tool provides) and associating specific events with each domain activity (e.g., creating a new question in the Question tool). Further, it may include designing a specific user interface via which data will be presented to the user, as well as work flows that indicate how the user can view, modify, or create data specific to that tool. This may further include associating specific events with user interface navigation (e.g., choosing items to view or view formats) and specific events for user input of data. The design process may also include designing the View Controller 1604 such that it coordinates events from the Domain Controller 1608 and the user interface components. The implementation of the View Controller 1604 may be straightforward if the workflows for the tool are well specified.

In one implementation, event types indicated with regard to FIG. 16 play a particular exemplary role in the operation of the tool which are described further in Table 1. Each event type includes an event category and a specific event type. The event categories indicate which component is responsible for the event definitions. For example, the events in the Msgr category are part of the specification of the Messenger 1415 itself and of the API via which components and the Messenger interact with one another. The exemplary event categories are as follows:

T—This event category comprises events that are specific to each tool. These events generally refer to information specific to the purpose and visual representation of the tool. The semantics of these events are local to the tool. If a category T event is transmitted to or through a generic component such as the Messenger 1415, in one implementation, then it is first transformed into binary format by a marshaller.

Msgr—This event category specifies interactions with the Messenger 1415.

RTS—This event category specifies interactions with the Recording Tag Service (“RTS”) 1611. The RTS 1611 is responsible for recording notable events that are presented as visual bookmark 1305 on the recording timeline 1303.

DT—This event category specifies interactions with the Directory 1414. Directory events are mediated by the User Controller 1603 within the tool. The User Controller 1603 is a re-usable component.

Menu—This event specifies interactions with the drop down menus 403.

UH—This event category specifies interactions with the User Controller 1603. The User Controller 1603 receives participant information from the Directory 1414, and makes it available to the tool in a variety of ways (for example, populating the drop-down menu 403 with specific sub-menus allowing the selection of an active user or group).

SUD—This event category specifies interactions between the User Controller 1603 and the View 1601 that are utilized to generate a dialogue box that allows the user to select a set of users or groups.

TABLE 1
Exemplary Event Schema for Tool

| | |
|---|---|
| Msgr: Reception | Indicates the arrival of a new message or status |
| | information about a message that was previously |
| | transmitted. |
| Msgr: Transmission | Informs the Messenger 1415 to transmit a |
| | message to all other instances of this tool on other |
| | machines. Tools use the Messenger 1415 when |
| | they need to reliably send a message to peer tool |
| | instances on other hosts. |
| RTS: Record | Informs the Recording Tag Service 1611 that a |
| | significant event has occurred that should be |
| | displayed 1305 on the Recording timeline 1303. |
| | Each tool determines in an ad hoc fashion which |
| | events should be recorded via the RTS 1611. |
| T: Model Data | Produced by the Domain Controller 1608 when |
| | underlying tool data has been created or |
| | modified. This can occur because the user has |
| | entered new data, or new data has arrived from a |
| | peer tool on another host. |
| T: Command | Informs the Domain Controller 1608 of new tool |
| | data that has been entered by the user. |
| DT: User Update | Indicates that participant information has changed |
| | and details the nature of those changes. |
| DT: Group Update | Indicates that information about participant |
| | groups has changed and indicates the nature of |
| | those changes. |
| Menu: Command | Indicates that the user has selected a command |
| | from the tool's menu. |
| Menu: Display | Configures the tool's menu display. This event |
| | may be generated by the View Controller 1604 to |
| | place tool specific commands in its drop-down |
| | menu, or by the User Controller 1603 when it |
| | builds a user/group selection sub-menu. |
| UH: Command | Indicates the selection of a user or group of users |
| | from the tool's menu. |
| UH: User Info | Indicates that participant information has changed |
| | and details the nature of those changes. |
| UH: Group Info | Indicates that information about participant |
| | groups has changed and indicates the nature of |
| | those changes. |
| UH: Menu Command | Indicates that the user has selected a user specific |
| | command from the tool's menu. |
| UH: Display | Configures the tool's menu to display a list of |
| | participants. |
| SUD: Display | Indicates that a user participant selection pop-up |
| | should be displayed. |
| SUD: Input | Indicates that the user has made a participant |
| | selection from the participant selection pop-up |
| | and details which users and groups were selected. |
| T: Display | Provides information to the View 1601 that it |
| | should display. This event is generated when the |
| | tool has new data to display, or the user has |
| | requested changes in the information displayed. |
| T: Nav | Tells the View 1601 to display information about |
| | a particular data item (when sent from View |
| | Controller 1604 to View). |
| T: Nav | Indicates that the user has selected a particular |
| | data item (when sent from View 1601 to View |
| | Controller 1604). |
| T: Input | Indicates that the user has entered some data into |
| | one of the fields on the tool's user interface (the |
| | data entered is provided with the event). |
| T: Layout | Indicates how the View 1601 should configure |
| | the visual representation shown to the user. This |
| | is typically generated when the user has requested |
| | a change to displayed information; either in form |
| | or in content. |

When sent from the View 1601 to the View Controller 1604, T-NAV indicates that the user has navigated to a particular item on the display (i.e., selected a question in the question tool). When sent from the View Controller 1604 to the View 1601, it tells the View to behave as though the user had navigated to a specific item. T-DISPLAY provides data about an item to be displayed.

There may be some degree of overlap between the DT events and the UH events. This results from all participant information events being routed through the User Controller 1603 rather than having participant information events directed at both the User Controller 1603 and the View Controller 1604. Routing these types of events through the User Controller 1603 ensures that the User Controller and View Controller 1604 always have a consistent interpretation of the current status of participants in a session.

The User Controller 1603 provides additional features to the overall structure of the tool, such as the redundancy of the participation events noted in the previous paragraph. In this same vein, the User Controller 1603 mediates control of the tool's drop down menu 401 in order to allow it to create participant selection sub-menus that vary dynamically with participant status. While it is possible to incorporate this functionality directly into the View Controller 1604, it may involve re-implementing the same features in each tool since participant selection actions may be are basically the same across all tools. To avoid this duplication of code, the common functionality for dealing with participant status, menus, and selection dialogs is extracted into a re-usable component, namely, the User Controller 1603.

In one implementation, four of the event groups described above have functionality specifically related to the playback of recorded sessions. These events include: T:Model Data, T:Nav, DT:User Update, and DT:Group Update. In one implementation, all interactions within the tool that involve these events groups are recorded in the Nexus 1607. For example, whenever the Domain Controller 1608 emits a T:Model Data event indicating that new tool specific data is available, that event is also recorded in the Nexus 1607 along with the time at which that event occurred relative to the beginning of the session. The recording of these four types of events is sufficient to play back the original session, as described in FIG. 17.

FIG. 17 depicts the software architecture of a tool 1408 in playback mode as shown in FIG. 14. The structure of the tool in Playback mode is similar to its structure in live mode. Some exemplary differences may be that there is an extra User Controller 1703 present, and the Recording Tag Service 1611 does not exist. Another difference may be that, rather than recording events as it does during a live session, the Nexus 1707 acts as a source of events. In particular, in one implementation, the Nexus 1707 can create an exact replay of the original streams of T:Model Data, T:Nav, DT:User Update, and DT:Group Update events with all inter-event timing preserved.

The playback of a given exemplary session may rely on the assumption that the Playback User Controller 1711, the View Controller 1704, and the View 1701 function as state machines. Thus, if a given sequence of T:Model Data events E₁, E₂, E₃ . . . Eₙ that occurred during the live session originally produced a particular configuration C₁ of the View 1601, then when that same sequence of events is played back out of the Nexus 1707 and into the View Controller 1704, it will produce exactly the same configuration C₁ of the View 1701. This same logic may apply to all of the event sequences generated by the Nexus 1707 and the components to which they are delivered. As long as these components (1711, 1704, 1701) operate as deterministic state machines with respect to the recorded event groups, the replay of these four types of events is sufficient to re-create the user's complete experience of the original live session.

It is possible to interpose new events into the playback stream, but that potentially creates additional restrictions on the nature of the events exchanged among tool components. In particular, events may not refer to data through relative locations (e.g., the item 2 rows upward in a given list), because interposed events may have altered relative positions. This issue can be resolved by assigning each data/display item a unique identifier.

Certain other components (1702, 1703, 1706, 1708, 1709, 1710) are present to support user interaction with the software during playback. In order to simplify handling of new information during playback, in one implementation, there are two User Controllers 1703, 1711 present for this example. One 1711 of these acts as the state machine for Nexus 1707 events and thus supports the playback function. The other 1703 exists to allow the user to interact directly with the tool as they would during a live session. Similarly, in one implementation, the Messenger 1710 plays no part in playback (as it has no Nexus 1707 connection), and exists to support user and tool interaction. This is also true of the Domain Controller 1708 and the DB Adapter 1709. The View Controller 1704 and View 1701 have dual functionality. While they continue to act as state machines with respect to Nexus events, they support an independent set of functionality that allows the user to interact with the tool as they would in a live session. If this additional functionality is truly independent of their playback behaviour, the invariants noted above are preserved.

FIG. 18 depicts an exemplary architecture of the recording and playback subsystem of the application, generally referred to as the Nexus 1413. FIG. 18 shows an exemplary configuration of the system for the playing back of data. The configuration during recording is simpler, in that the event buffers 1803 may not be utilized.

During recording, the Media Stream 1802 receives events directly from the various tools. As the event is received, it is marked with the current time (for example, with a resolution of milliseconds) and then appended to an end of the list of recorded events that it is maintaining internally. In one implementation, it also writes the event out to disk 1801 along with meta-information indicating that the event was appended to the event list. This last action is part of the journaling infrastructure that allows recordings to be recovered if the system fails prior to writing the internal event list out to disk.

The Nexus 1413 also supports various editing operations including the ability to delete recorded events and insert events into the recorded event stream. Each of these operations may comprise two distinct actions on the part of the Nexus 1413. First, the internal event list is modified accordingly. For example, if the operation is to delete a particular event, then that event is deleted from the internal list. Second, a record of the event including what operation was performed and what event was being operated on is written out to a journal file (not shown), in one implementation, while a live session is being recorded. The recordings and journal file may use the same underlying file format.

The journal file, thus, contains a complete history of every operation that was carried out on the Nexus 1413. The internal state of the Nexus 1413 can thus be re-created by simply re-executing the operation stream from the journal file. Once the journal file has been re-executed, the Nexus 1413 can then write out the internal event to disk. Through this mechanism, the journal file can be used to recover recordings that were not completed correctly due to application or machine failures.

Each recording is stored as a single file on disk 1801. When playback of recording is initiated, this file is read, and parts of the recording are transferred to main memory associated with the Media Stream 1802. In order to achieve real-time playback as well as the re-writing of time stamps, possibly necessitated by editing operations, the system orchestrates the movement of data between main memory and disk.

Recording meta-data may be maintained in main memory, for example, after being read from disk in playback, or written to memory in a live session. Editing operations that involve re-writing of timestamps operate very quickly in an in-memory data structure within the Media Stream 1802 and can thus occur in real-time. For events that are associated with a small amount of application data (such as short textual questions asked by students), that data may also be kept in main memory. For events associated with a larger quantity of application data (such as the image data used by the presentation broadcast tool), the data is stored on disk, and the in-memory data structure retains a reference to the appropriate disk location for the event data.

During playback, quality of service for latency/jitter sensitive streams may be achieved through the use of an exemplary multi-threaded event distribution system. The Media Stream 1802 includes an internal thread that determines when each event's playback time has been reached. At that time, it hands the event over to the event distribution system. The event distribution system includes a set of two-sided buffers 1803, one buffer for each distinct event class. When the time arrives for an event to be played, the Media Stream 1802 places the event in the buffer 1803 corresponding to its class, which is stored as meta data associated with each event. Having the event's class stored as meta-data (i.e., separate from the event itself) allows the code to route the event to the correct buffer).

A transfer thread 1804 associated with each buffer 1803 removes events from the buffer 1803 and delivers them to the application layer and tools 1805 for processing. This use of separate threads 1804 to deliver independent event classes, coupled with appropriate thread priority levels, ensures that low latency/jitter can be maintained for those event streams that need it, even in the presence of other event streams that can pose large and varying loads on the CPU. Playback of an event of a given class may delay delivery of events of that class. Other event classes, since they are served by independent threads 1804, are unaffected, at least to the degree that the operating system is capable of fairly allocating processing resources among the threads.

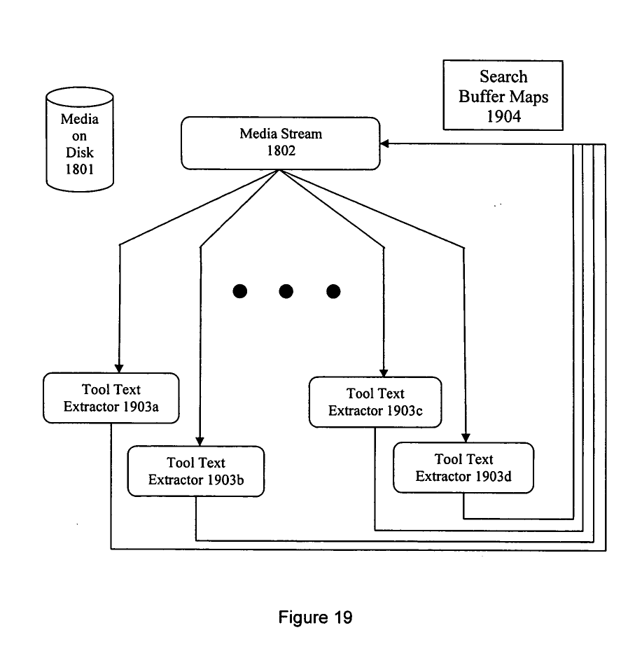

FIG. 19 depicts an architecture of an exemplary subsystem that is responsible for the generation of exemplary search indices that enable rapid searching of the textual content of the recordings. Search indices may be generated during a post-processing step that occurs after the recording has been made. During this post-processing step, search indices are generated, and then injected back into the recording as meta-data.

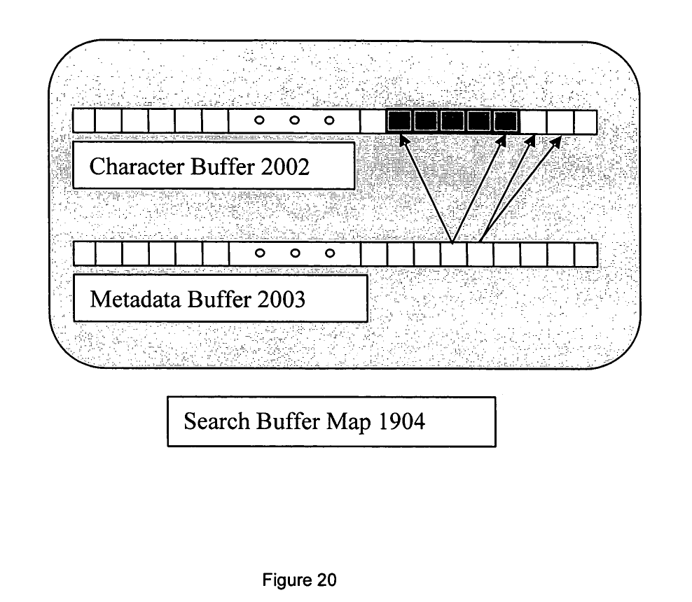

The architecture for search index generation may be a specialization of the Nexus architecture used for the recording and playback as described in FIG. 18. The Media Stream 1802 manages data read from the disk 1801 in the same manner as it would for playing back events. However, in this configuration, event data is not passed through event buffers 1803, but is instead is passed directly to exemplary tool text extractors 1903. There is one tool text extractor 1903 for each tool used in the recording. The tool text extractors 1903 examine each event that is delivered to them by the Media Stream 1802 and constructs a search buffer map 1904, which is described further below with respect to FIG. 20.

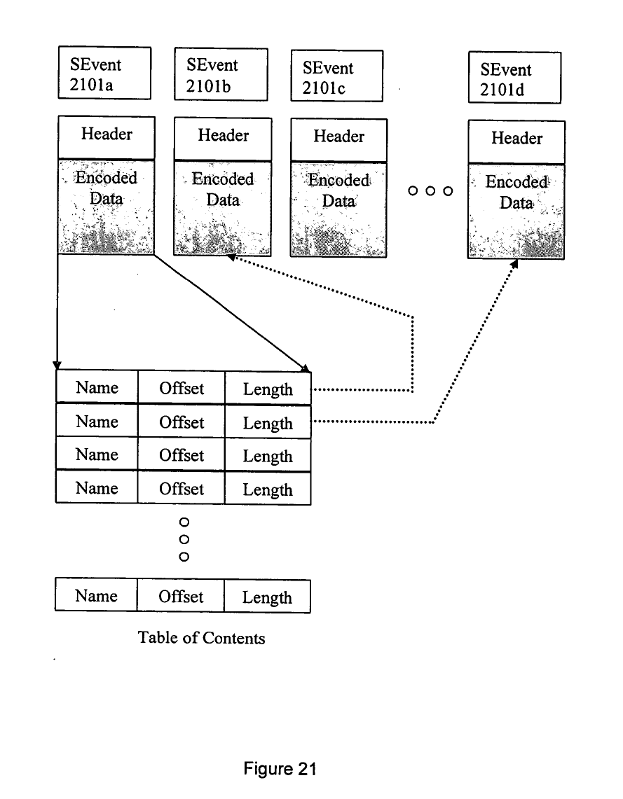

In one implementation, once all the events in the recording have been passed through the tool text extractors 1903, an end-of-stream indication is sent to each of them. Upon receiving this notification, each tool text extractor 1903 takes the search buffer map 1904 that it has constructed and passes it back to the Media Stream 1802. The Media Stream 1802 appends these indices to the actual recording and makes meta-data entries that indicate the recording has been indexed. The format of this meta-data is discussed further with regard to FIG. 21.

FIG. 20 shows an exemplary in-memory format of an exemplary search buffer map 1904; a data format designed for carrying out searches of timed event data. During playback, the indices are read from the recording file and re-constituted in memory in the form shown. The search buffer map 1904 includes a character buffer 2002 and a meta-data buffer 2003. The character buffer 2002 is an array containing all the text associated with a given tool from a particular session. For example, the search buffer map 1904 for the Question tool may contain the text of all the questions asked and answered in a given session. Text is recorded in the order in which it was entered originally during the session. Thus, if a student asks question Q1 initially, and then question Q2 later in the session, the character buffer 2002 will contain the text of Q1 first and then the text of Q2. The meta-data buffer 2003 contains information about the time within the session during which the text in the character buffer 2002 was generated, and whether that text should be considered as part of a contiguous block of text for search purposes. Each entry in the metadata buffer 2003 corresponds to a specific range of entries in the character buffer 2002. In one implementation, each entry in the character buffer 2002 is covered by exactly one entry from the metadata buffer 2003.

Text searches against the recording are executed by taking the search string and locating occurrences of that string within the character buffer 2002. A given search match is represented by a contiguous range of indices in the character buffer 2002. This range of indices corresponds to one or more contiguous entries in the meta-data buffer 2003. If the meta-data buffer entries indicate that the search crosses a text boundary, then the match is discarded. Otherwise, the timestamp for the matching text is extracted from the first metadata entry, and that timestamp is recorded as part of the result set. The result set for a given search buffer map 1904 thus comprises of a series of timestamps at which search matches were detected, along with the matching text (and possibly some surrounding context).

The application carries out a complete search of a recording by carrying out the process described above for each search buffer map 1904 associated with the recording. As noted previously, in one implementation, there is one search buffer map 1904 associated with each tool that was used during the session. A complete search result thus comprises a set of search hits, wherein each search hit may contain: (1) a tool identification which uniquely identifies the tool in which the match occurred, (2) an instance identification which distinguishes different instances of a particular tool used within a session, (3) a timestamp indicating the moment in the recording at which the matching text was generated or received and (4) the matching text (potentially including some context around the precise matching location). These search hits can then be displayed to the user. When the user selects a particular search hit, they have the option of going into that recording to the particular point in time associated with the search hit.

FIG. 21 depicts an exemplary format for a recording on disk. The recording may be a sequence of data structures referred to as SEvents 2101. Each SEvent 2101 may contain meta-data in one implementation, stored in the header, that defines: (1) the tool that produced the data, (2) that instance of that tool, (3) the time at which the data was produced, and (4) the length of the data block associated with the SEvent. Generally speaking, the data blocks associated with SEvents 2101 are produced by the marshallers which are generated by the event compiler (see the discussion regarding FIG. 14). However, some of the SEvents 2101 in the recording are not produced by tools, but rather by components of the recording infrastructure.

In one implementation, the first SEvent 2101 of recording is a special Table of Contents entry that is generated and maintained by the Media Stream 1802 (see FIG. 18). The Table of Contents is a sequence of entries that describe different sections of the recording. Each section has a name, an offset in the file at which it begins, and the length of that section in bytes. Each section is composed of a sequence of SEvents 2101. The dashed lines represent the TOC entries referring to their corresponding sections in the file. Section types may include, but are not limited to: (1) MainEventStream, (2) ToolMetaData, (3) SessionMetaData, (4) SearchBuffer, and (5) JournalStream. The MainEventStream section may contain the actual session data as produced by all of the tools used in that session. The ToolMetaData section stores arbitrary name/value pairs that are managed via a tool meta-data interface provided by the Media Stream 1802. For example, the Note tool uses the tool meta-data facility to store the user supplied name for each instance of the Note tool. The SessionMetaData section stores arbitrary name/value pairs that are managed via a session meta-data interface provided by the Media Stream 1802. For example, the start time and duration of a given session are stored as session meta-data. The SearchBuffer section stores the search buffer maps 1604 described in FIG. 20. Each tool's search buffer map 1604 may be stored as a single SEvent 2101. The JournalStream section is used when writing a journal file. A journal file includes a JournalStream section. All of the other sections are encoded into the JournalStream because each operation on the media stream is written to the journal stream. Thus all the other streams can be re-created from the journal stream. The journal file may be discarded once the underlying media stream has been successfully flushed to disk.

The disk format of a recording is controlled by the Media Stream 1802 (see FIG. 18). The Media Stream 1802 is thus responsible for creating and maintaining the Table of Contents 2102, as well as ensuring that data is correctly placed into the other sections.

The foregoing description of an implementation in accordance with the present invention has been presented for purposes of illustration and description. It is not exhaustive and is not limited to the precise form disclosed. Modifications and variations are possible in light of the above teachings or may be acquired from practice. For example, the described implementation includes software but the present invention may be implemented as a combination of hardware and software or in hardware alone. Note also that the implementation may vary between systems. Methods and systems in accordance with the present invention may be implemented with both object-oriented and non-object-oriented programming systems. The claims and their equivalents define the scope of the invention.

1. A method in data processing system for collaboration, comprising the steps of:
receiving a first request to perform an operation synchronously with a live session by a collaboration tool;
executing the operation in response to the first synchronous request by the collaboration tool;
receiving a second request to perform the same operation asynchronously with the live session by the collaboration tool; and
executing the operation in response to the second asynchronous request by the collaboration tool.

2. The method of claim 1, further comprising the steps of:
receiving the first request via a graphical user interface; and
receiving the second request via the graphical user interface.

3. The method of claim 1, wherein executing the operations in response to the first request further comprises the steps of:
detecting the presence of another user to determine whether the user is online; and
executing the operation based on the determination.

4. The method of claim 3, wherein executing the operation based on the determination further comprises the step of:
delaying execution of the operation based the determination.

5. The method of claim 1, wherein the operation comprises sending a question.

6. The method of claim 5, wherein the operation comprises sending an answer in response to a question.

7. The method of claim 1, wherein the operation comprises sending a file.

8. The method of claim 1, wherein the operation comprises sending a quiz.

9. The method of claim 8, wherein the operation comprises sending a response to a quiz.

10. A method in a data processing system having a collaboration tool, the method comprising the steps performed by the collaboration tool of:
displaying a graphical user interface including a plurality of operations;
receiving a first request to perform one of the operations in a synchronous manner; and
receiving a second request to perform the one operation in an asynchronous manner.

11. The method of claim 10, further comprising the step of:
performing the one operation.

12. A method in a data processing system for collaboration, comprising the steps of:
recording a live interactive presentation with interactive elements; and
playing the recording of the live presentation such that a user is able to interact with the interactive elements.

13. The method of claim 12, further comprising the step of:
creating a recording using a collaboration tool.

14. The method of claim 13, further comprising the step of:
providing, during playback of the recording, interactive elements of the collaboration tool available during creation of the recording.

15. The method of 13, wherein the collaboration tool comprises:
a note tool.

16. The method of 13, wherein the collaboration tool comprises:
a question and answer tool.

17. The method of claim 13, wherein the collaboration tool comprises:
a file transfer tool.

18. The method of 13, wherein the collaboration tool comprises:
a quiz tool.

19. The method of 13, wherein the collaboration tool comprises:
a presentation broadcast tool.

20. A data processing system for collaboration, comprising:
a memory comprising a program that receives a first request to perform an operation synchronously with a live session by a collaboration tool, executes the operation in response to the first synchronous request by the collaboration tool, receives a second request to perform the same operation asynchronously with the live session by the collaboration tool, and executes the operation in response to the second asynchronous request by the collaboration tool; and
a processor for running the program.

21. The data processing system of claim 20, wherein the program further receives the first request via a graphical user interface, and receives the second request via the graphical user interface.

22. The data processing system of claim 20, wherein the program further detects the presence of another user to determine whether the user is online, and executes the operation based on the determination.

23. The data processing system of claim 22, wherein program further delays execution of the operation based the determination.

24. The data processing system of claim 20, wherein the operation comprises sending a question.

25. The data processing system of claim 24, wherein the operation comprises sending an answer in response to a question.

26. The data processing system of claim 20, wherein the operation comprises sending a file.

27. The data processing system of claim 20, wherein the operation comprises sending a quiz.

28. The data processing system of claim 20, wherein the operation comprises sending a response to a quiz.

29. A data processing system having a collaboration tool, comprising:
a memory comprising a program that causes a collaboration tool to display a graphical user interface including a plurality of operations, receive a request to perform one of the operations in a synchronous manner, and receive a request to perform the one operation in an asynchronous manner; and
a processor for running program.

30. The data processing system of claim 29, wherein the collaboration tool is further configured to perform the one operation.

31. A data processing system for collaboration, comprising:
a memory comprising a program that records a live interactive presentation with interactive elements, and plays the recording of the live presentation such that a user is able to interact with the interactive elements; and
a processor for running the program.

32. The data processing system of claim 31, wherein the program further creates a recording using a collaboration tool.

33. The data processing system of claim 32, wherein the program further provides, during playback of the recording, interactive elements of the collaboration tool available during creation of the recording.

34. The data processing system of 32, wherein the collaboration tool comprises:
a note tool.

35. The data processing system of 32, wherein the collaboration tool comprises:
a question and answer tool.

36. The data processing system of claim 32, wherein the collaboration tool comprises:
a file transfer tool.

37. The data processing system of 32, wherein the collaboration tool comprises:
a quiz tool.

38. The data processing system of 32, wherein the collaboration tool comprises:
a presentation broadcast tool.

39. A computer-readable medium containing instructions for controlling a data processing system for collaboration to perform a method comprising the steps of:
receiving a first request to perform an operation synchronously with a live session by a collaboration tool;
executing the operation in response to the first synchronous request by the collaboration tool;
receiving a second request to perform the same operation asynchronously with the live session by the collaboration tool; and
executing the operation in response to the second asynchronous request by the collaboration tool.

40. The computer-readable medium of claim 39, wherein the method further comprises the steps of:
receiving the first request via a graphical user interface; and
receiving the second request via the graphical user interface.

41. The computer-readable medium of claim 39, wherein executing the operations in response to the first request further comprises the steps of:
detecting the presence of another user to determine whether the user is online; and
executing the operation based on the determination.

42. The computer-readable medium of claim 41, wherein executing the operation based on the determination further comprises the step of:
delaying execution of the operation based the determination.

43. The computer-readable medium of claim 39, wherein the operation comprises sending a question.

44. The computer-readable medium of claim 43, wherein the operation comprises sending an answer in response to a question.

45. The computer-readable medium of claim 39, wherein the operation comprises sending a file.

46. The computer-readable medium of claim 39, wherein the operation comprises sending a quiz.

47. The computer-readable medium of claim 46, wherein the operation comprises sending a response to a quiz.

48. A computer-readable medium containing instructions for controlling a collaboration tool in a data processing system for collaboration to perform a method comprising the steps of:
displaying a graphical user interface including a plurality of operations;
receiving a request to perform one of the operations in a synchronous manner; and
receiving a request to perform the one operation in an asynchronous manner.

49. The computer-readable medium of claim 48, wherein the method further comprises the step of:
performing the one operation.

50. A computer-readable medium containing instructions for controlling a data processing system for collaboration to perform a method comprising the steps of:
recording a live interactive presentation with interactive elements; and
playing the recording of the live presentation such that a user is able to interact with the interactive elements.

51. The computer-readable medium of claim 50, wherein the method further comprises the step of:
creating a recording using a collaboration tool.

52. The computer-readable medium of claim 51, wherein the method further comprises the step of:
providing, during playback of the recording, interactive elements of the collaboration tool available during creation of the recording.

53. The computer-readable medium of 51, wherein the collaboration tool comprises:
a note tool.

54. The computer-readable medium of 51, wherein the collaboration tool comprises:
a question and answer tool.

55. The computer-readable medium of claim 51, wherein the collaboration tool comprises:
a file transfer tool.

56. The computer-readable medium of 51, wherein the collaboration tool comprises:
a quiz tool.

57. The computer-readable medium of 51, wherein the collaboration tool comprises:
a presentation broadcast tool.

58. A data processing system for collaboration, comprising:
means for receiving a first request to perform an operation synchronously with a live session by a collaboration tool;
means for executing the operation in response to the first synchronous request by the collaboration tool;
means for receiving a second request to perform the same operation asynchronously with the live session by the collaboration tool; and
means for executing the operation in response to the second asynchronous request by the collaboration tool.
